(19) United States
(12) Patent Application Publication
(10) Pub. No.: US 2009/0004589 A1
(43) Pub. Date: Jan. 1, 2009

(54) Toner and Process for Producing the Same

(75) Inventors: Yasuhito Yuasa, Osaka (JP); Mamoru Soga, Osaka (JP); Hidekazu Arase, Hyogo (JP); Masahisa Maeda, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 12/162,538

(22) PCT Filed: Nov. 28, 2006
(86) PCT No.: PCT/JP2006/323666

§ 371 Date: Jul. 29, 2008

(30) Foreign Application Priority Data
Feb. 3, 2006 (JP) 2006-026828

(51) Int. Cl. G03G 9/09; G03G 9/08; G03G 5/00

(52) U.S. Cl. 430/108.8; 430/108.9; 430/137.14

(57) ABSTRACT

The present invention provides toner containing core particles prepared by mixing and aggregating in an aqueous medium at least a first resin particle dispersion in which first resin particles are dispersed, a colorant particle dispersion in which particles of colorant are dispersed and a wax particle dispersion in which particles of wax are dispersed. The colorant contains carbon black having a DBP oil absorption of 45 to 70 (ml/100 g) and the wax contains a wax having an endothermic peak temperature (referred to as melting point Tmw1 (° C.)) according the DSC method of 50 to 90° C. It is thus possible to prepare toner that has a small particle size and a sharp particle size distribution without requiring a classification process and that can prevent transfer void and toner scattering during transfer and obtain high transfer efficiency. The present invention provides also a method for producing the toner.

### TECHNICAL FIELD

The present invention relates to toner for use in copiers, laser printers, regular paper facsimiles, color PPC, color laser printers, color facsimiles or multifunctional devices and to a method for producing the toner.

### BACKGROUND ART

Recently, the purpose of image forming apparatuses such as printers is shifting from office use to personal use, and techniques to make the image forming apparatuses small and fast and to make the image forming apparatuses produce high-quality images and color images are required. Under such circumstances, a tandem color process and oilless fixing are required as well as better maintenance property and less ozone emission. The tandem color process enables high-speed output of color images. The oilless fixing can provide clear color images with high glossiness, transmittance and offset resistance even when no fixing oil is used to prevent offset during fixing. These functions should be performed simultaneously, and therefore improvements in the toner characteristics as well as the processes are important factors.

In a fixing process for color images in color printers, each color of toner is melted and then mixed so as to increase the transmittance. A melt failure of the toner may cause scattering of light on the surface or the inside of the toner images, and the original color of the toner pigment is impaired. Moreover, light does not reach the lower layers of the superimposed images, resulting in poor color reproduction. Therefore, a toner is required to have a property of being completely melted and have a transmittance such that a color tone is not impaired. In addition, oilless fixing in which silicone oil or the like is not used in fixing needs to be achieved. To achieve oilless fixing, e.g., toner in which a release agent is added to a binder resin having a sharp melt property is being brought into practical use.

However, such toner is very prone to a transfer failure or a variation in toner images during transfer because of its strong aggregability. Therefore, it is difficult to ensure compatibility between transfer and fixing. In the case of two-component development, spent (i.e., a low-melting point component of the toner is adhered to the carrier surface) is likely to occur by heat generated by mechanical collision or friction between the particles or between the particles and the developing unit thereby impairing the charging ability of the carrier and hindering the extension of life of the developer.

A toner is composed of a resin component that is generally a binder resin, a pigment, a charge controlling agent, and as necessary an additive component such as a release agent, and the ingredients are pre-mixed in a suitable proportion, heat-kneaded by thermofusion, pulverized by an air stream collision board method, and subjected to a fine-powder classification, thereby producing toner base particles. In addition, there is a method by which toner base particles are prepared according to a chemical polymerization method. Then, an additive such as hydrophobic silica is added to the toner base particles, so that the toner is completed. The single component development typically uses the toner only, while the two-component development uses a developer containing the toner and a carrier of magnetic particles.

With pulverization and classification of the conventional kneading and pulverizing method, the particle size that can be attained in reality in view of the economical and performance aspects is limited even when particles of a small size are made.

Then, methods for producing toner using various polymerization methods have been investigated that are different from the kneading and pulverizing method. For example, when toner is prepared according to the suspension polymerization method, although the particle size distribution of the toner is controlled, it is difficult to attain a particle size distribution narrower than that of the toner produced according to the kneading grinding method, and often a further classification operation is required. Moreover, toners obtained according to such methods have a problem of their shape being nearly completely spherical, and thus the cleanability of the toners remaining in a photoconductive member and the like is poor, impairing image quality reliability.

Patent document 1 discloses toner composed of particles formed by polymerization and a coating layer composed of fine particles formed on the surface of the particles by emulsion polymerization, and discloses a scheme to form the coating layer of fine particles on the surface of the particles by adding a water-soluble inorganic salt and a scheme to form a coating layer of fine particles on the surface of the particles by changing the pH of the solution.

Patent document 2 discloses a method for producing toner including a process of preparing an aggregated particle dispersion by forming aggregated particles in a dispersion in which at least resin particles are dispersed, a process of preparing adhered particles by adhering fine resin particles to the aggregated particles by admixing with the aggregated particle dispersion a fine resin particle dispersion in which fine resin particles are dispersed, and a process of fusing by heating the adhered particles, and discloses that the admixing method can be performed gradually continuously or in a stepwise manner by dividing the method into steps. In addition, patent document 2 discloses an effect brought about by admixing the fine resin particles (additional particles) in which the generation of fine particles is inhibited, the particle size distribution is sharp, and chargeability is excellent.

Patent document 3 discloses a configuration to enhance hygroscopic resistance by forming toner that has a surfactant content of 3 wt. % or less and contains an inorganic metal salt such as zinc chloride in an amount of 10 ppm to 1 wt. % that is at least divalent by an ionic crosslink. After preparing an aggregate dispersion by mixing a fine resin particle dispersion with a colorant dispersion using an inorganic metal salt, the dispersion is heated to the glass transition temperature or higher of the resin and the aggregate is thus fused, thereby forming toner. Toner of a small particle size that has excellent charging characteristics, environmental dependency, cleanability, transferability, and a sharp particle size distribution is disclosed.

Patent document 4 discloses toner particles on which a resin layer (shell) in which resin particles are fused according to the salting-out/fusion method on the surface of coloring particles (core particles) containing a resin and a colorant is formed. Patent document 4 discloses a configuration in which, following the salting-out/fusion process for obtaining the coloring particles, a dispersion of the resin particles is added to a dispersion of the coloring particles, and a temperature higher than the glass transition temperature is maintained. Patent document 4 discloses effects that the toner has a small amount of the colorant on the particle surface and, even when subjected to image formation over a long period of time in a high humidity environment, a change of image density, fogging and a change of tint resulting from a change of chargeability/developability does not occur.

Patent document 5 discloses black toner containing toner particles containing at least a binder resin and carbon black having a DBP oil absorption of 70 to 120 ml/100 g. The carbon black is finely dispersed and the size distribution of the dispersed particles is sharp, and therefore even with a comparatively low coating amount, the desired image density can be achieved, and it is easy to be charged to a predetermined charge amount. Therefore, the problem of creating the transfer void as a result of an electrical transfer failure by the oppositely charged toner can be prevented sufficiently. Moreover, patent document 5 sets forth an effect that the charging environmental stability and stress resistance are superior.

When the DBP oil absorption of carbon black is excessively small, the carbon black has less affinity with the binder resin, and the carbon black is likely to move toward the toner surface in the toner particles and is thus not finely dispersed. Therefore, the desired image density and the desired charge amount are not achieved. On the other hand, when the DBP oil absorption of carbon black is excessive, there is a problem of the circularity decrease caused by the deterioration of shape controllability at the time of toner particle production. Moreover, when the DBP oil absorption of carbon black is excessively, carbon black is less likely to be wet by water, thereby impairing the dispersion stability of a water dispersion of the carbon black. Patent document 5 sets forth an effect that when toner is produced using such carbon black having low dispersion stability, aggregation is likely to occur and particle growth cannot be controlled properly, and therefore, the dispersibility of the carbon black in the toner is impaired, resulting in transfer void and undesirable charge amount.

Patent document 1: JP S57-045558A

Patent document 2: JP H10-073955A

Patent document 3: JP H11-311877A

Patent document 4: JP 2002-116574A

Patent document 5: JP 2005-221836A

In the examples of conventional art given above, a method in which a certain amount of a wax having a low melting point is added in order to enhance the fixability, i.e., achieving oilless fixing. However, it is likely that, when aggregated particles are generated by aggregating the wax with resin particles or the like in an aqueous medium, the particle size becomes large as the heat treatment proceeds, making it difficult to generate particles of a small diameter having a narrow particle size distribution.

In addition, it is likely that, with a method in which the temperature of the aqueous system and the speed of stirring are changed to prevent the particle size from being large, conversely, a uniform mixed aggregation of resin particles, particles of wax and the pigment particles of colorant in the aqueous system is inhibited, and the resin particles and the particles of wax are not incorporated into the particles of colorant in the aqueous system, resulting in the creation of suspended wax that is not involved in the aggregation and pigment particle residues.

When carbon black is used as the pigment, this trend emerges prominently. Compared with other organic pigments such as phthalocyanine, quinacridone, azo and like, carbon black particles shows properties similar to those of inorganic pigments, and carbon black particles have specific DBP oil absorption characteristics. When aggregated particles are formed by a heat treatment in an aqueous medium by aggregation with resin particles and particles of wax, if the aggregation reaction is progressed at a heating temperature set to be at the melting point of the wax or higher, the wax is in the state of being molten and the carbon black particles are in the state of a powder. The carbon black particles having specific DBP oil absorption characteristics oil-absorb (adsorb) the molten wax due to the oil absorbability thereof. As a result, it is likely that gray particles in which the carbon black particles and the wax are fused are generated. In addition, it is likely that some particles grow large, and a suspended wax that is not involved in aggregation and the residue of pigment particles are generated due to the imbalance of the particles in the aqueous system.

When the molten wax is oil-absorbed (adsorbed) by the carbon black particles, the intrinsic fixability of the wax, such as low-temperature fixability or offset resisting, are impaired, and thus it is likely that the fixable temperature range is reduced.

The aggregation reaction between the carbon black particles in the form of a powder having specific DBP oil absorption characteristics and the molten wax is likely to influence the particle formation upon the aggregation reaction in the aqueous system as well as the fixability of the wax.

When suspended particles of wax and carbon black particles remain, the charge amount is decreased, the adhesion of toner to a non-image portion is increased, and the filming of toner to a photoconductive member and a transfer material occurs. Moreover, when the dispersibility of the wax and pigment particles, especially the carbon black, in the coloring particles is impaired, color turbidity is likely to occur in the image created by the toner melted during fixing, making the color creation of the toner insufficient.

Furthermore, although a core-shell structure in which toner particles are obtained by fusing shell resin particles with the surface of coloring particles (core particles) is disclosed, when the shell resin particles are fused with the core particles containing the aforementioned wax according to a method in which a shell is created by mixing a core particle dispersion with a shell resin dispersion in which the shell resin particles are dispersed and heating the mixture, there is a case in which the adhesion barely progresses due to the presence of the wax which makes the adhesion of the shell resin particles unstable, or a case in which the shell resin particles are desorbed from the core particles, even after the shell resin particles are adhered to the core particles, due to the mold release action of the wax once the wax is molten in the subsequent heating treatment.

### DISCLOSURE OF INVENTION

The present invention can produce toner that has a small particle size and a sharp particle size distribution without requiring a classification process and that can prevent transfer void and toner scattering during transfer and obtain high transfer efficiency, and a method for producing the toner.

The toner of the present invention contains core particles prepared by mixing and aggregating in an aqueous medium at least a first resin particle dispersion in which first resin particles are dispersed, a colorant particle dispersion in which particles of colorant are dispersed and a wax particle dispersion in which particles of wax are dispersed. The colorant contains carbon black having a DBP oil absorption of 45 to 70 (ml/100 g) and the wax contains a wax having an endothermic peak temperature (referred to as melting point Tmw1 (° C.)) according the DSC method of 50 to 90° C.

The method for producing of a toner of the present invention includes the steps of preparing a mixture by mixing in an aqueous medium at least a first resin particle dispersion in which first resin particles are dispersed, a colorant particle dispersion in which particles of colorant are dispersed and a wax particle dispersion in which particles of wax are dispersed, preparing core particles by adding an aggregating agent to the mixture, aggregating the first resin particles, the particles of colorant and the particles of wax, and fusing the first resin particles, the particles of colorant and the particles of wax, and fusing second resin particles with the core particles by adding a second resin particle dispersion in which the second resin particles are dispersed to the core particle dispersion containing the core particles, followed by heating. The colorant contains carbon black having a DBP oil absorption of 45 to 70 (ml/100 g) and the wax contains a wax having an endothermic peak temperature (referred to as melting point Tmw1 (° C.)) according to the DSC method of 50 to 90° C.

### BRIEF DESCRIPTION OF DRAWINGS

FIG. 1 is a cross-sectional view showing a configuration of an image forming apparatus used in an example of the present invention.

FIG. 2 is a cross-sectional view showing a configuration of a fixing unit used in an example of the present invention.

FIG. 3 is a schematic view of a stirring/dispersing device used in an embodiment of the present invention.

FIG. 4 is a schematic view of a stirring/dispersing device used in an embodiment of the present invention.

FIG. 5 is a graph showing fogging characteristics in an embodiment of the present invention.

### BEST MODE FOR CARRYING OUT THE INVENTION

With respect to the present invention, in the toner containing core particles prepared by mixing and aggregating particle dispersions in which resin particles, particles of colorant and particles of wax are dispersed, carbon black having a DBP oil absorption of 45 to 70 (ml/100 g) is contained, and the wax contains a wax having an endothermic peak temperature (referred to as melting point Tmw1 (° C.)) according the DSC method of 50 to 90° C. Therefore, the problem that the suspended wax and carbon black particles that are not incorporated into the core particles and not involved in the aggregation remain in the aqueous system can be solved, and particles that have a small particle size and a sharp particle size distribution can be produced. In addition, by fusing second resin particles with the core particles, effects to enhance durability, charge stability, high-temperature offset resistance and storage stability can be obtained. Furthermore, in the tandem color process in which image forming stations that have a plurality of photoconductive members and developing units are arranged in series and transfer processes are continuously carried out by supplying toners of various colors in sequence to transfer materials, transfer void and reverse transfer during transfer can be prevented, and high transfer efficiency can be obtained.

Below, descriptions are given according to each process.

(1) Polymerization and Aggregation Process

A resin particle dispersion is prepared by forming resin particles of a homopolymer or copolymer (vinyl resin) of vinyl monomers by emulsion or seed polymerization of the vinyl monomers in a surfactant and dispersing the resin particles in the surfactant. Any known dispersing devices such as a high-speed rotating emulsifier, a high-pressure emulsifier, colloid emulsifier, a media-equipped ball mill, sand mill, dynomill, etc., can be used.

When the resin particles are made of resin other than the homopolymer or copolymer of the vinyl monomers, a resin particle dispersion may be prepared in the following manner. If the resin dissolves in an oil solvent that has a relatively low water solubility, a solution is obtained by mixing the resin with the oil solvent. The solution is blended with a surfactant or polyelectrolyte and then is dispersed in water to produce a fine particle dispersion by using a dispersing device such as a homogenizer. Subsequently, the oil solvent is evaporated by heating or under reduced pressure. Thus, the resin particles made of resin other than the vinyl resin are dispersed in the surfactant.

The colorant particle dispersion is prepared by adding color particles to water to which a surfactant has been added and dispersing the particles using an aforementioned dispersion means.

The wax particle dispersion is prepared by adding particles of wax to water to which a surfactant has been added, and dispersing the particles of wax using a suitable dispersion means.

The toner is required to have further low-temperature fixability, high-temperature offset resistance in oilless fixing, mold releasability, high transmittance for color images, storage stability at certain high temperatures, and these properties have to be satisfied simultaneously.

In the present invention, the core particles are prepared by mixing and aggregating in an aqueous medium at least a resin particle dispersion in which first resin particles are dispersed, a colorant particle dispersion in which particles of colorant are dispersed and a wax particle dispersion in which particles of wax are dispersed. At this time, the colorant contains carbon black having a DBP oil absorption of 45 to 70 (ml/100 g), and the wax contains a wax having an endothermic peak temperature (referred to as melting point) according the DSC method of 50 to 90° C. The DBP oil absorption is preferably 45 to 63, more preferably 45 to 60, and still more preferably 45 to 53.

When core particles are prepared by aggregating resin particles in combination with the wax having a melting point of 50 to 90° C. and carbon black as a colorant, due to the use of the wax, which starts to melt at low temperatures, and carbon black, which has high aggregability and demonstrates fast particle growth, there is a tendency that, as described above, gray particles are generated and core particles grow coarse, making it difficult to prepare particles that have a small particle size and a sharp particle size distribution.

However, if particles of a small particle size are to be produced while preventing the core particles from becoming coarse through temperature control, stirring speed control, etc., carbon black is not incorporated into the core particles, carbon black grows into particles faster, carbon black particles that are not involved in the aggregation remain in the core particle dispersion, and the reaction fluid stays black opaque and is unlikely to be transparent. Moreover, residues of the particles of wax that are not involved in the aggregation also are observed, and there is a tendency that the particle size distribution becomes broad.

Therefore, in the aggregation reaction that shall be described later of the wax that has a specific melting point and is in a molten state and the carbon black particles of a powder state, the inventors found that the following effects can be obtained by using carbon black particles having a specific DBP oil absorption: the phenomenon in which carbon black particles grow sooner can be prevented and even when core particles having a small particle size are prepared, carbon black particles that are not involved in the aggregation and remain in the core particle dispersion can be eliminated. In addition, the inventors also found another effect, i.e., the phenomenon in which the fixability intrinsic to a wax is deteriorated can be prevented.

Although the reason is not understood clearly, it may be because of the influence from the phenomenon of the carbon black particles having a specific DBP oil absorption being oil-absorbed (adsorbed) into the molten wax. It is presumed that with carbon black having a DBP oil absorption more than 70, the aggregation of carbon black is likely to occur soon and carbon black particles are unlikely to be incorporated into the core particles. Moreover, it is presumed that the phenomenon of the oil absorption (adsorption) into the molten wax rapidly progresses, resulting in generating gray particles. In addition, it is presumed that the fixability of the wax is also deteriorated. Carbon black having a DBP oil absorption of less than 45 is difficult to obtain.

It is essential to use a wax having a melting point of 50 to 90° C. to attain low-temperature fixing. Preferably, the melting point is 55 to 85° C., more preferably 58 to 85° C., and still more preferably 68 to 74° C. When the melting point is lower than 50° C., aggregation progresses excessively fast, and the prepared core particles are likely to be coarse. In addition, the stability in high-temperature storage is impaired. When the melting point exceeds 90° C., the low-temperature fixability and color glossiness are not improved.

In the present invention, it is preferable that the principal component of the surfactant for use in preparing the first resin particle dispersion is a nonionic surfactant, and the principal component of the surfactants for use in the colorant particle dispersion and the wax particle dispersion is a nonionic surfactant. In the above, the term “principal component” means that the component accounts for 50 wt. % or more of the surfactant for use.

In the present invention, the surfactant for use in the first resin particle dispersion preferably contains nonionic surfactant in a proportion of 50 to 95 wt. % based on the entire surfactant, more preferably 55 to 90 wt. %, and still more preferably 60 to 85 wt. %. Furthermore, it is preferable that each surfactant for use in the colorant particle dispersion and the wax particle dispersion contains nonionic surfactant in a proportion of 50 to 100 wt. % based on the entire surfactant, more preferably 60 to 100 wt. %, and still more preferably 60 to 90 wt. %.

With respect to the surfactants for use in the particle dispersions, it is preferable that the proportion of ionic surfactant (anionic surfactant is preferable) based on the entire surfactant is larger in the first resin particles than in the particles of colorant and is larger in the particles of colorant than in the particles of wax.

First, the first resin particles in which an anionic surfactant is used in a higher proportion start to aggregate and nuclei are formed, and then the particles of colorant in which an anionic surfactant is used in a proportion higher than in the particles of wax start to aggregate around the resin particle nuclei. Finally, the particles of wax in which a nonionic surfactant is used in the highest proportion aggregate. It is presumed that core particles are formed such that the particles of wax aggregate so as to wrap around the particles of colorant together with the resin particles. The fact that the first resin particles start to aggregate and form nuclei first is considered to be the point to avoid the phenomenon of the particles of colorant and the particles of wax not being incorporated into the core particles or the particles of colorant and the core particles not being involved in the aggregation and remaining.

In the present invention, it is preferable that the surfactant for use in the first resin particle dispersion is a mixture of a nonionic surfactant and an ionic surfactant, and the surfactants for use in the wax particle dispersion and the colorant particle dispersion is solely of a nonionic surfactant.

When an aggregating agent acts in an aqueous medium using such resin particles, particles of colorant and particles of wax, the resin particles start to aggregate first and form nuclei. Then, the particles of colorant start to aggregate around the resin particle nuclei. Finally, the particles of wax aggregate and wrap around the particles of colorant as if sandwiching the particles of colorant with the resin particles. It is presumed that since the resin particles are usually added in an amount several times more than the particles of colorant and the particles of wax in terms of weight concentration, nuclei composed solely of the resin particles are aggregated over the particles of wax, and thereby a toner whose outermost surface is covered with the resin is formed. It is considered that due to this mechanism the presence of suspended particles of colorant and particles of wax that are not involved in the aggregation in the aqueous system is eliminated, and core particles having a small particle size and a uniform and sharp particle size distribution within a narrow range can be formed.

Furthermore, in the embodiment with the mixed system of a nonionic surfactant and an ionic surfactant, in the surfactant for use in the first resin particle dispersion, nonionic surfactant is preferably used in a proportion of 50 to 95 wt. % based on the entire surfactant. More preferably, it is 55 to 90 wt. %, and still more preferably 60 to 85 wt. %. The use of nonionic surfactant in a proportion of 50 wt. % or more can prevent the phenomenon of the particle size distribution of the prepared core particles being broad. The use of nonionic surfactant in a proportion of 95 wt. % or less produces an effect to stabilize the dispersed state of the resin particles in the resin particle dispersion. An anionic surfactant is preferable as the ionic surfactant.

With respect to the dispersions in which the particles of colorant and the particles of wax are dispersed solely with nonionic surfactants, it is preferable that the average number of moles of ethylene oxide added to the nonionic surfactant used to disperse the particles of wax is larger than the average number of moles of ethylene oxide added to the nonionic surfactant used to disperse the particles of colorant. The lower the average number of moles of ethylene oxide added to the nonionic surfactant, the more likely the particles become aggregated due to an aggregating agent.

The average number of moles of ethylene oxide added to the nonionic surfactant used to disperse the pigment particles is preferably 18 to 33, more preferably 20 to 30, and still more preferably 20 to 26.

When the average number of moles of ethylene oxide added to the nonionic surfactant is less than 18, the aggregability of the pigment particles due to the use of an aggregating agent is excessively high, growing into large particles before being incorporated into the resin, and as a result not being incorporated into the toner particles. On the contrary, when the average number of moles of ethylene oxide added to the nonionic surfactant exceeds 33, the aggregability due to the use of an aggregating agent is excessively low, and fine carbon black particles do not aggregate and remain in the reaction fluid as fine particles, not being incorporated into the toner particles. It is also preferable that the nonionic surfactant used to disperse the pigment particles contains a plurality of nonionic surfactants. Even when the average number of moles of ethylene oxide added to a single nonionic surfactant is not in the range of 20 to 30, it is sufficient that the weight-average number of moles of ethylene oxide added to the plurality of nonionic surfactants is in the range of 20 to 30.

Here, the aggregability of the particles of each type due to the use of an aggregating agent can be evaluated according to the concentration of the aggregating agent when aqueous solutions (for example, aqueous magnesium sulfate solutions) of an aggregating agent of various concentrations are added dropwise to the particle dispersions and particles aggregate to a specific size. The higher the aggregability due to the use of the aggregating agent, the lower the aggregating agent concentration with which particles aggregate.

When an aggregating agent is used in a fluid using such resin particles, particles of colorant and particles of wax, the resin particles in which an anionic surfactant is used start to aggregate first and form nuclei. Then, the particles of colorant in which a nonionic surfactant having a small average number of moles of ethylene oxide added is used start to aggregate around the resin particle nuclei. Finally, the particles of wax in which a nonionic surfactant having a large average number of moles of ethylene oxide added is used aggregate, and it is presumed that the particles of wax aggregate as if the particles of colorant are wrapped around together with the resin particles, thereby forming core particles.

It is presumed that, thereby, the phenomenon, i.e., the particles of colorant and the particles of wax are not incorporated into the core particles, and the particles of colorant and the core particles that are not involved in aggregation remain, can be avoided.

The amount of nonionic surfactant relative to the pigment particles is preferably 10 to 20 parts by weight per 100 parts by weight of carbon black from the viewpoint of dispersion stability.

With respect to the present invention, as one embodiment of the core particle formation, the first resin particle dispersion in which the first resin particles are dispersed, the colorant particle dispersion in which the particles of colorant are dispersed and the wax particle dispersion in which the particles of wax are dispersed are mixed in an aqueous medium, the pH of the mixed dispersion is controlled under specific conditions, and a water-soluble inorganic salt is added. Thereby, core particles in which the first resin particles, the particles of colorant and the particles of wax are aggregated are prepared. By heating the aqueous medium to the glass transition temperature (Tg) of the first resin particles or higher and/or the melting point of the wax or higher, core particles that are at least partially molten can be prepared.

With respect to the resin particle dispersion, when a persulfate such as potassium persulfate is used as a polymerization initiator in preparing an emulsion polymerization resin by polymerization, the residue thereof may decompose by the heat during the heat aggregation process and change (lower) the pH. Therefore, it is preferable to perform a heat treatment higher than a specific temperature (preferably 80° C. or higher to sufficiently disperse the residue) for a specific period of time (preferably about 1 to about 5 hours) after emulsion polymerization. The pH of the resin particle dispersion is preferably 4 or less, and more preferably 1.8 or less.

The pH of the aforementioned mixed dispersion preferably is controlled to 9.5 to 12.2, more preferably 10.5 to 12.2, and still more preferably 11.2 to 12.2. The pH can be controlled by adding 1N NaOH. The pH of 9.5 or more produces an effect to prevent the phenomenon of the prepared core particles being coarse. The pH of 12.2 or less produces an effect to inhibit the generation of suspended particles of wax and suspended particles of colorant, thereby enabling the wax and the colorant to be readily contained within.

After controlling the pH of the mixed dispersion, a water-soluble inorganic salt is added and heat treatment is performed, thereby forming core particles having a specific volume-average particle size in which at least part of at least the first resin particles, the particles of colorant and the particles of wax are melted and aggregated. By controlling the pH of the fluid to be in the range of 7.0 to 9.5 when the core particles having this specific volume-average particle size are formed, the wax barely remains in the fluid, and core particles having a narrow particle size distribution in which the wax is contained can be formed. The amount of NaOH to be added, the type and amount of the aggregating agent, the pH of the emulsion polymerization resin dispersion, the pH of the colorant dispersion, the pH of the wax dispersion, and the heating temperature and time can be selected suitably. When the pH of the fluid is 7.0 or less when the particles are formed, the core particles tend to be coarse. When the pH exceeds 9.5, a large amount of the wax remains due to poor aggregation.

The measurement of pH (hydrogen ion concentration) may be carried out by collecting a 10 ml sample from a measuring liquid in a container using a pipet, introducing the sample into a beaker of about the same volume, immersing the beaker in cold water, cooling the sample to room temperature (30° C. or less), dipping a measurement probe in the sample cooled to room temperature using a pH meter (Seven Multi: Mettler-Toledo International Inc.), and reading the value on the meter display once stable, and this is regarded as the pH value.

After controlling the pH of the mixed dispersion, the temperature of the mixed dispersion is increased while stirring the dispersion. The rate of temperature increase is preferably 0.1 to 10° C./min. Productivity is reduced when the rate is low. When the rate is excessively high, the particle shape tends to be excessively spherical before the particle surface becomes smooth.

In the method for producing a toner of the present invention, as one preferable embodiment of core particle preparation, a mixed dispersion is prepared by mixing the first resin particle dispersion, the colorant particle dispersion and the wax particle dispersion in an aqueous medium. And, after heating this mixed dispersion and after the fluid of the mixed dispersion reaching a specific temperature, it is preferable to add to the mixed dispersion a water-soluble inorganic salt as an aggregating agent.

By adding an aggregating agent when the mixed dispersion is in the state of reaching a specific temperature, the phenomenon in which aggregation occurs slowly as the heatup time passes can be avoided and an agglutination reaction advances rapidly with the addition of the aggregating agent, and thus it is possible to prepare core particles in a short period of time. In addition, it makes it possible to prepare core particles that have a small particle size and a sharp particle size distribution in which a wax and a colorant are uniformly contained.

Moreover, when waxes of different melting points are used in combination as described below, in the process increasing the temperature, the wax of a lower melting point starts to melt first, and as the temperature increase progresses, the wax of a higher high melting point starts to melt, and then aggregation starts. Therefore, it is a method effective also to prevent the formation of aggregates of the particles of wax which has a lower melting point as well as the formation of aggregates of the particles of wax which has a higher melting point. By preventing uneven distribution of the wax in the core particles, broadening of the particle size distribution of the core particles and the uneven shape distribution thereof can be prevented.

An aqueous solution containing a water-soluble inorganic salt in a predetermined water concentration is used as the aggregating agent to be added. It is also preferable to add the aqueous solution after controlling the pH thereof to the mixed dispersion in which at least the first resin particle dispersion in which the first resin particles are dispersed, the colorant particle dispersion in which the particles of colorant are dispersed and the wax particle dispersion in which the particles of wax are mixed.

It is presumed that by controlling the pH of the aqueous solution containing the aggregating agent to a specific value, the aggregating action of the particles as the aggregating agent can be further enhanced. It is preferable to maintain a specific relationship with the pH of the mixed dispersion. When an aqueous aggregating agent solution that has a pH quite different from that of the mixed dispersion is added, the pH balance of the fluids suddenly is disturbed, and it is likely that the aggregated particles become coarse and the wax is dispersed unevenly. To prevent these phenomena, it is effective to control the pH of the aqueous solution containing the aggregating agent.

The mixed dispersion in which the first particle dispersion, the colorant particle dispersion and the wax particle dispersion are mixed are heat treated, and when the pH of the mixed dispersion before the addition of the aqueous solution containing the aggregating agent is HG, the pH of the aqueous solution containing the aggregating agent is preferably controlled to be in the range of HG+2 to HG−4, and the aqueous solution is then added. The pH of the aqueous solution is preferably in the range of HG+2 to HG−3, more preferably HG+1.5 to HG−2, and still more preferably HG+1 to HG−2.

When an aqueous aggregating agent solution that has a quite different pH is added to the mixed dispersion, the pH balance of the fluids is disturbed suddenly. It is therefore likely that the aggregation reaction is slowed and does not progress smoothly, or aggregated particles become coarse. To prevent these phenomena, it is effective to control the pH of the aqueous aggregating agent solution. For unknown reasons, it is considered more preferable to control the pH of the aqueous aggregating agent solution to be lower than the pH of the mixed dispersion.

When the pH of the aqueous aggregating agent solution is HG−4 or more, the aggregating action of the particles as the aggregating agent can be further enhanced, accelerating the aggregation reaction. When the pH of the aqueous aggregating agent solution is HG+2 or less, effects of preventing the phenomena that the aggregated particles become coarse and the particle size distribution becomes broad can be obtained.

A preferable time to add the aggregating agent is after the temperature of the mixed dispersion in which the first resin particle dispersion, the colorant particle dispersion and the wax particle dispersion are mixed reaches or exceeds the melting point of the wax measured according to the DSC method which shall be described later. It is presumed that by adding the aggregating agent while melting of the wax has already started, the aggregation of the molten particles of wax with the resin particles and the particles of colorant progresses at once, and by continuing the heat treatment, melting of the particles of wax and the resin particles proceeds, resulting in particle formation.

At this time, even if the aggregating agent is added when the temperature of the mixed dispersion reaches the glass transition point of the first resin particles, particles barely aggregate, not resulting in particle formation. By adding the aggregating agent when the temperature of the mixed dispersion reaches the specific temperature of the wax, the aggregation of the particles advances and then by performing a heat treatment for 0.5 to 5 hours, preferably 0.5 to 3 hours, and more preferably 1 to 2 hours, core particles having a specific particle size distribution is prepared. The heat treatment may be carried out while maintaining the specific temperature of the wax, but it is preferable to heat at 80 to 95° C. and more preferably 90 to 95° C. Thereby, the aggregation reaction can be accelerated, contributing to shortening the treatment time.

Moreover, as described below, when two or more types of waxes are contained, it is preferable to control to the specific temperature of the wax that has the lowest melting point. It is more preferable to control to the specific temperature of the wax having the highest melting point. It is effective to add the aggregating agent in a temperature condition in which melting of particles of wax has started.

For the addition of the aggregating agent, the entire aggregating agent may be added at once, and it is also preferable to add the aggregating agent dropwise taking 1 to 120 min. Dropwise addition may be carried out batch-wise, and it is preferably carried out continuously. By adding the aggregating agent dropwise to the heated mixed dispersion at a predetermined rate, the aggregating agent gradually and uniformly mixes with the entire mixed dispersion in a reaction vessel, thereby exhibiting an effect of preventing the particle size distribution from being broad due to uneven distribution and the generation of suspended particles of the wax and the colorant. In addition, a sudden decrease of the fluid temperature of the mixed dispersion can be suppressed. The aggregating agent is preferably added over 5 to 60 min, more preferably 10 to 40 min, and still more preferably 15 to 35 min. With the time of 1 min or longer, core particles of irregular shapes do not grow, and a uniform shape is obtained. With the time of 120 min or less, an effect of suppressing the presence of particles that are independently suspended due to the poor aggregation of the particles of colorant and the particles of wax can be obtained.

It is preferable that the aggregating agent is added dropwise in a proportion of 1 to 50 parts by weight relative to the total sum of the first resin particles, the fine pigment particles and the fine particles of wax as 100 parts by weight. Preferably, it is 1 to 20 parts by weight, more preferably 5 to 15 parts by weight, and still more preferably 5 to 10 parts by weight. There is a tendency that when the amount is excessively small, the aggregation reaction does not progress, and when the amount is excessive, the prepared particles are coarse.

The mixed dispersion may contain ion exchange water in addition to the first resin particle dispersion, the colorant particle dispersion and the wax particle dispersion to control the solid concentration of the mixed dispersion. The solid concentration of the mixed dispersion is preferably 5 to 40 wt. %.

With respect to the aggregating agent, it is also preferable to treat the water-soluble inorganic salt with ion exchange water or the like to a specific concentration, and then the water-soluble inorganic salt is used. The concentration of the aqueous aggregating agent solution is preferably 5 to 50 wt. %.

In the present invention, it is also preferable that a second resin particle dispersion in which second resin particles are dispersed is admixed with the core particle dispersion in which the core particles are dispersed, and the second resin particles are fused with the core particles by a heat treatment, thereby preparing toner base particles.

In the toner of the present invention, the pigment and the wax are incorporated inside the toner. However, there is a possibility that an ultralow amount of the pigment and wax may be present on the outermost surface. When these pigment and wax are accumulated inside an electrophotographic apparatus, the imaging quality is affected adversely. Therefore, for preventing such a problem also, it is preferable to form a fusion layer (may also be referred to as a shell layer) on the core particles by fusing the second resin particles with the core particles. In addition, it is preferable to form as a shell layer resin particles containing resin particles having a glass transition point (Tg (° C.)) from the viewpoint of improving the storage stability of the toner in a high temperature condition, fine emulsified resin particles of a high molecular weight from the viewpoint of securing high-temperature offset resistance, or a charge regulator from the view point of charge stability.

In the fusion of the second resin particles with the core particles, the conditions of adding dropwise the second resin particles to the core particles are such that the second resin particles preferably are added dropwise at a rate of 0.14 parts by weight/min to 2 parts by weight/min per 100 parts by weight of the prepared core particles.

More preferably, the rate is 0.15 parts by weight/min to 1 part by weight/min, and still more preferably 0.2 parts by weight/min to 0.8 parts by weight/min.

The time to add the second resin particle dispersion is when the core particles reach a specific particle size, and the second resin particle dispersion is added as is. The dropwise addition preferably is performed sequentially. When the entire dispersion is added at once or when the dispersion is added in an amount exceeding 2 parts by weight/min, it is likely that the second resin particles only are aggregated with each other and the particle size distribution is broad. Moreover, when the dispersion is added in large amounts, the fluid temperature is decreased rapidly, and the progress of the aggregation reaction is terminated, sometimes resulting in that the second resin particles partially remain in the state being suspended in the aqueous system without being involved in the adhesion to the core particles.

When the rate is lower than 0.14 parts by weight/min, the amount of the second resin particles partially adhered to the core particles is reduced, and when heating is continued, the core particles aggregate with each other, and thus it is likely that the particles become coarse and the particle size distribution becomes broad.

By carrying out the dropwise addition of the second resin particle dispersion under suitable conditions, the aggregation of only the core particles with each other and the aggregation of only the second resin particles with each other can be prevented, thereby enabling particles that have a small particle size and a sharp particle size distribution to be prepared.

It is preferable to add dropwise the second resin particle dispersion such that the change of the fluid temperature of the core particle dispersion in which the prepared core particles are dispersed is within 10%.

In the fusion of the second resin particles with the core particle, when a resin fusion layer is formed by adding the second resin particle dispersion in which the second resin particles are dispersed to the core particle dispersion and fusing the second resin particles with the core particles by heat treatment, it is preferable to add the second resin particle dispersion after controlling the pH value thereof to be within a specific range. In particular, it is more effective to combine with the conditions of the dropwise addition of the second resin particle dispersion.

The purpose of adding the second resin particle dispersion without disturbing the pH balance of the fluids is to prevent the generation of second resin particles that are suspended and are not involved in the fusion, to make the adhesion of the second resin particles to the core particles favorable, and to prevent the secondary aggregation of the core particles with each other.

The pH requirements of the second resin particle dispersion are such that when the pH of the core particle dispersion in which the core particle are dispersed is HS, it is preferable to add the second resin particle dispersion in which the resin particles are dispersed while the pH thereof is controlled to be in the range of HS+4 to HS−4. Preferably, the pH of the second resin particle dispersion is in the range of HS+3 to HS−3, more preferably in the range of HS+3 to HS−2, and still more preferably in the range of HS+2 to HS−1.

When a second resin particle dispersion having a pH quite different from that of the core particle dispersion is added, the pH balance of the fluids is suddenly disturbed, resulting in that the second resin particles do not adhere to the core particles or the prepared particles are coarse due to the secondary aggregation of the core particles. To prevent such a phenomenon, it is effective to control the pH of the second resin particle dispersion. Thereby, the generating of suspended particles from the second resin particles is reduced, and uniform adhesion of the second resin particles to the core particle surface can be carried out. In addition, the adhesion to the core particles is enhanced and the fusion processing time can be shortened, thereby improving productivity. Moreover, in the case of fusing the second resin particles with the core particles, rapid coarsening of the particles can be prevented, and thus it is possible to obtain a small particle size with a sharp particle size distribution. By controlling the pH of the second resin particle dispersion to HS+4 or less, the tendency of the particles to become coarse and to have a broad particle size distribution can be reduced. By controlling the pH of the second resin particle dispersion to HS−4 or more, the adhesion of the second resin particles to the core particles is advanced, and the fusion processing can be performed in a short period of time. Moreover an effect to prevent the phenomenon in which the reaction does not progress while the second resin particles are not involved in the fusion and remain suspended in the aqueous system and the fluid stays white turbid can be obtained.

In an embodiment in which the second resin particles are fused with the core particles, the pH of the second resin particle dispersion in which the second resin particles to be added to the core particle dispersion are dispersed is preferably controlled to be in the range of 3.5 to 11.5 regardless of the pH of the core particle dispersion in which the core particles are dispersed, and then the second resin particle dispersion is added. More preferably, the pH of the second resin particle dispersion is in the range of 5.5 to 11.5, still more preferably 6.5 to 11, and even more preferably 6.5 to 10.5.

By controlling the pH to 3.5 or more, the adhesion of the second resin particles to the surface of the aggregated particles is advanced, and the phenomenon in which second resin particles are suspended in the aqueous system and the fluid stays white turbid can be prevented. By controlling the pH to 11.5 or less, the tendency of the prepared particles rapidly becoming coarse can be reduced.

By controlling the pH of the second resin particle dispersion in which the second resin particles are dispersed to be relatively high in the range of HS to HS+4, the generation of the secondary aggregation of the core particles with each other can be regulated, and thus it is also possible to control the shape of the toner base particles that eventually are prepared when the second resin particles are added.

This can be realized by controlling the pH of the second resin particle dispersion to be added to a value close to or higher than the pH of the core particle dispersion in which the core particles are dispersed and then adding the second resin particle dispersion. By controlling the pH to be in this range, part of the core particles undergoes secondary aggregation when the second resin particles are adhered by fusing with the core particles, thereby enabling the shape of the particles to be controlled from spherical to potato-shaped.

This is because there is a strong tendency for the shape of a toner to be determined according to the conformity with the development, transfer and cleaning processes, and when a priority is given to the cleanability of the photoconductive member and the transfer belt, the toner not in a spherical shape but in a potato shape provides easier cleaning. In addition, when a priority is given to transferability, the shape of the toner is made close to spherical, and transfer efficiency is enhanced.

The principal component of a surfactant for use in the second resin dispersion is preferably a nonionic surfactant, and it is further preferable that a surfactant for use in the second resin particle dispersion is a mixture of a nonionic surfactant and an ionic surfactant. In this embodiment, it is preferable that the nonionic surfactant is used in a proportion of 50 to 95 wt. % based on the entire surfactant. More preferably, it is 55 to 90 wt. %, and still more preferably 60 to 85 wt. %. The use of nonionic surfactant in a proportion of 50 wt. % or more can enhance the adhesion of the fine second resin particles to the core particles. The use of nonionic surfactant in a proportion of 95 wt. % or less produces an effect of stabilizing the dispersed state of the resin particles themselves in the resin particle dispersion.

After the coloring particles are formed, cleaning, liquid-solid separation and drying processes may be performed as desired to provide toner base particles. The cleaning process preferably involves sufficient substitution cleaning with ion exchange water from the viewpoint of enhancing the chargeability. The liquid-solid separation process is not particularly limited, and any known filtration methods such as suction filtration and pressure filtration can be used preferably from the viewpoint of productivity. The drying process is not particularly limited, and any known drying methods such as flash-jet drying, flow drying, and vibration-type flow drying can be used preferably from the viewpoint of productivity.

A water-soluble inorganic salt is selected as the aggregating agent, and examples include alkali metal salts and alkaline earth metal salts. Examples of alkali metals include lithium, potassium, sodium, etc., and examples of alkaline-earth metals include magnesium, calcium, strontium, barium, etc. Among such examples, potassium, sodium, magnesium, calcium and barium are preferable. Examples of counter ions (anions that form salts) of the aforementioned alkali metals or alkaline earth metal include chloride ion, bromide ion, iodide ion, carbonate ion, sulfate ion, etc. It is also preferable to use the aggregating agent after diluting it to a specific concentration with ion exchange water or the like.

Examples of nonionic surfactants include higher alcohol ethylene oxide adducts, alkylphenol ethylene oxide adduct, fatty acid ethylene oxide adduct, polyhydric alcohol fatty acid ester ethylene oxide adduct, fatty acid amide ethylene oxide adduct, ethylene oxide adduct of fat and oil, polypropylene glycol ethylene oxide adduct, and like polyethylene glycol nonionic surfactants; glycerol fatty acid ester, pentaerythritol fatty acid ester, sorbitol fatty acid ester, sorbitan fatty acid ester, sucrose fatty acid ester, polyhydric alcohol alkyl ether, alkanolamine fatty acid amide, and like polyhydric alcohol nonionic surfactants; and the like.

Higher alcohol ethylene oxide adduct, alkylphenol ethylene oxide adduct and like polyethylene glycol nonionic surfactants can be used particularly preferably.

Examples of aqueous media include water such as distilled water, ion exchange water and the like, alcohols, etc. These may be used singly or in combination of two or more members. The amount of the aforementioned polar surfactant in the aforementioned dispersing agent having polarity generally cannot be specified, and suitably can be selected according to the purpose.

In addition, when a nonionic surfactant and an ionic surfactant are used in combination, examples of polar surfactants include sulfate-based, sulfonate-based, phosphate-based, soap-based or like anionic surfactants; amine salt-type, quaternary-ammonium salt-type or like cationic surfactants; etc.

Examples of the aforementioned anionic surfactant are sodium dodecylbenzene sulphonate, sodium dodecyl sulfate, sodium alkylnaphthalene sulfonate, sodium dialkylsulfosuccinate, etc.

Examples of the cationic surfactants include alkylbenzene dimethylammonium chloride, alkyl trimethylammonium chloride, distearyl ammonium chloride, etc. These may be used singly or in a combination of two or more members.

(2) Wax

In oilless fixing in which no oil is used in a fixing roller, in order to improve the low-temperature fixability, high-temperature offset resistance or releasability from the heating roller or the like of transfer media such as copy paper or the like to which molten toner is applied upon fixing, and in addition, to broaden the margin of conflicting fixing characteristics such as low-temperature fixability, high-temperature offset resistance and storage stability, and to enhance the functionality thereof, it is preferable to add a wax, and it is more preferable to add a plurality of waxes.

In the present invention, a wax contains at least a wax having an endothermic peak temperature of 50 to 90° C. It is essential to use a wax having a low melting point to attain low-temperature fixing. Preferably, the endothermic peak temperature is 55 to 85° C., more preferably 58 to 85° C., and still more preferably 68 to 74° C. When the endothermic peak temperature is lower than 50° C., storage stability is impaired. When the endothermic peak temperature is higher than 90° C., low-temperature fixability and color glossiness do not improve.

Although the use of a wax having a low melting point is advantageous to attain low-temperature fixing, as described above, when conventional carbon black particles are used, there is a tendency that due to the oil absorption (adsorption) of a wax and carbon black particles that are both in a molten state, the formation of particles of a small size and the fixability are adversely affected. Then, the use of carbon black having a specific DBP oil absorption is effective.

In the present invention, it is preferable to add a plurality of waxes. In the first preferable example, a wax containing a first wax and a second wax of which the endothermic peak temperature (referred to as the melting point Tmw1 (° C.)) according to the DSC method of the first wax is 50 to 90° C. and the endothermic peak temperature (melting point Tmw2 (° C.)) according to the DSC method of the second wax is 80 to 120° C. is selected. The Tmw1 is preferably 55 to 85° C., more preferably 58 to 85° C., and still more preferably 68 to 74° C. The Tmw2 is preferably 85 to 100° C. and more preferably 90 to 100° C. Due to the use of waxes that have different melting points, the roles of the waxes are divided, and thus characteristics such as achievement of low-temperature fixing and high-temperature offset resistance and a broad fixing temperature range can be obtained. However, due to the use of carbon black that has strong aggregability and fast particle growth and the use of waxes having different melting points, aggregates of low-melting point particles of wax and aggregates of high-melting point particles of wax are likely to be generated in the aqueous medium, and a dispersion state in which waxes are distributed unevenly in the core particles is likely to be created. Moreover, carbon black particles and particles of wax that are not involved in the aggregation are likely to remain in the core particle dispersion, and it is likely that the particle size distribution of the core particles becomes broad and the shape becomes nonuniform.

Then, as described above, by the use of specific carbon black particles, carbon black particles and particles of wax that are not involved in aggregation and remain in the core particle dispersion can be lessened, and core particles that have a small particle size and a sharp particle size distribution can be prepared.

When the Tmw1 is 50° C. or less, the prepared core particles are likely to be coarse, and the storage stability thereof is poor. When the Tmw1 exceeds 90° C., there is a tendency that the low-temperature fixability and color glossiness do not improve. When the Tmw2 is 80° C. or less, the high-temperature offset resistance and paper releasability are tend to be weak. When the Tmw2 exceeds 120° C., it is likely that the aggregability of the wax is deteriorated, suspended particles that do not aggregate are increased in the aqueous system, and the shape becomes nonuniform.

Moreover, in the second example of using a plurality of waxes, it is preferable that the wax contains at least a first wax and a second wax, the first wax contains an ester wax composed of at least a higher alcohol having 16 to 24 carbon atoms or a higher fatty acid having 16 to 24 carbon atoms, and the second wax contains an aliphatic hydrocarbon wax.

Moreover, in the third example of using a plurality of waxes, it is preferable that the wax contains at least a first wax and a second wax, the first wax contains a wax having an iodine value of 25 or less and a saponification value of 30 to 300, and the second wax contains an aliphatic hydrocarbon wax.

In the second and third examples of preferable waxes, the endothermic peak temperature (melting point Tmw1 (° C.)) according to the DSC method of the first wax is 50 to 90° C., more preferably 55 to 85° C., still more preferably 58 to 85° C., and even more preferably 68 to 74° C. When the endothermic peak temperature is 50° C. or less, the storage stability and heat resistance of the toner are impaired. When the endothermic peak temperature exceeds 90° C., the aggregability of the wax is reduced, and suspended particles that are not aggregated are increased in the aqueous system. Moreover, the low-temperature fixability and glossiness do not improve. Furthermore, the endothermic peak temperature (melting point Tmw2 (° C.)) according to the DSC method of the second wax is 80 to 120° C., preferably 85 to 100° C., and more preferably 90 to 100° C. When the endothermic peak temperature is 80° C. or less, the storage stability is impaired, and the high-temperature offset resistance and the releasability of paper are poor. When the endothermic peak temperature exceeds 120° C., the aggregability of the wax is reduced, and suspended particles that do not participate in the aggregation are increased in the aqueous system. Moreover, the low-temperature fixability and color transmittance are impaired.

In the second and third examples of preferable waxes, when core particles are formed with the resin, the colorant and the aliphatic hydrocarbon wax in an aqueous system, the aliphatic hydrocarbon wax tends not to aggregate with the resin due to the low affinity with the resin, and it is likely that suspended particles are from the wax not being incorporated into the core particles and the aggregation of the core particles do not progress, resulting in a broad particle size distribution.

In addition, when the temperature and time of the heat treatment are changed in order to prevent the suspended particles and prevent the particle size distribution from being broad, the particle size becomes large. Moreover, when a shell is created, the phenomenon in which the core particles rapidly grow coarse.

Thus, by using the wax that contains the first wax containing a specific wax in conjunction with the second wax containing a specific aliphatic hydrocarbon wax, the presence of suspended particles resulting from the aliphatic hydrocarbon wax not being incorporated into the core particles can be suppressed, the broadening of the particle size distribution of the core particles can be prevented, and the phenomenon in which the core particles rapidly grow coarse when a shell is created can be prevented.

It is presumed that in heat aggregation, due to the advancement of the compatibilization between the first wax and the resin, the aggregation of the aliphatic hydrocarbon wax and the resin is promoted, they are uniformly incorporated, and the generating of suspended particles can be prevented. In addition, due to the partial advancement of the compatibilization between the first wax and the resin, the low-temperature fixability tends to further improve. And, since the compatibilization between the aliphatic hydrocarbon wax and the resin does not progress readily, this wax can exhibit the function to better the high-temperature offset resistance and the paper releasability. That is, the first wax has a function as a dispersing aid in the emulsification dispersion treatment of the aliphatic hydrocarbon wax as well as a function as an auxiliary agent for low-temperature fixing.

When a plurality of waxes are added and when core particles are formed by aggregating the particles of wax having different melting points with the first resin particles and the particles of colorant in an aqueous system, if a dispersion in which the first wax and the second wax are separately subjected to an emulsification dispersion treatment is mixed with the resin dispersion and the colorant dispersion and aggregated by heating, it is likely that, due to the difference in melting rate of the waxes, suspended particles resulting from the waxes not being incorporated into the core particles are present and a broad particle size distribution is created because the aggregation of the core particles barely progresses, and the waxes are thereby not uniformly incorporated into the toner, sometimes making it difficult to form core particles that have a small particle size and a sharp particle size distribution. Moreover, the problem that the prepared particles rapidly become coarse when the second resin particles are adhered to the core particles by fusion (hereinafter sometimes referred to as shell formation) also cannot be solved sufficiently.

Then, it is preferable that, in the preparation of a wax particle dispersion, the dispersion is prepared by subjecting the first wax and the second wax to a mixed emulsification dispersion treatment. This is a method for subjecting the first wax and the second wax to a heat emulsification dispersion treatment in a specific ratio in an emulsification dispersion apparatus. The introduction of the first wax and the second wax may be separate or simultaneous, and it is preferable that in the eventually obtained dispersion the first wax and the second wax are contained in the state of being mixed.

In the first, second and third examples of preferable waxes, when the weight ratio of the first wax based on 100 parts by weight of the waxes in the wax particle dispersion is ES1 and the weight ratio of the second wax is FT2, FT2/ES1 is 0.2 to 10, more preferably in the range of 1 to 9, and still more preferably in the range of 1.5 to 5. When FT2/ES1 is less than 0.2, i.e., when the weight ratio of the first wax is excessive, the effect of the high-temperature offset resistance cannot be obtained, and the storage stability is deteriorated. When FT2/ES1 exceeds 10, i.e., when the weight ratio of the second wax is excessive, low-temperature fixing cannot be attained, and the aforementioned problem that the core particles are likely to become coarse is not solved. Furthermore, FT2 of 50 wt. % or more and preferably 60 wt. % or more is a well-balanced ratio that can achieve simultaneously the low-temperature fixability, high-temperature storage stability and high-temperature offset resistance during fixing.

In the first, second and third examples of preferable waxes, when a wax, especially an aliphatic hydrocarbon wax, is treated with an anionic surfactant, although the dispersion stability is improved, the core particles become coarse in the aggregation of the core particles, making it difficult to obtain particles having a sharp particle size distribution.

Then, it is preferable to prepare a wax particle dispersion by subjecting the first wax and the second wax to a mixed emulsification dispersion treatment using a surfactant containing as a principal component a nonionic surfactant. By preparing an emulsified dispersion through mixing and a dispersion treatment using a surfactant containing as a principal component a nonionic surfactant, the aggregation of the wax itself is suppressed, enhancing the dispersion stability. And, using these waxes in the preparation of aggregated particle with the resin dispersion and the colorant dispersion, the core particles that have a small particle size and a sharp particle size distribution can be formed.

In the first, second and third examples of the wax, the wax is preferably added in a total amount of 5 to 30 parts by weight per 100 parts by weight of the binder resin. Preferably, it is 8 to 25 parts by weight, and more preferably 10 to 20 parts by weight. When it is less than 5 parts by weight, the effects of the low-temperature fixability, high-temperature offset resistance and the paper releasability cannot be exhibited. When it exceeds 30 parts by weight, it is difficult to control the particles to have a small diameter.

In the first, second and third examples of the wax, it is preferable that Tmw2 is higher than Tmw1 by 5° C. or more and 50° C. or less. More preferably, Tmw2 is higher by 10° C. or more and 40° C. or less, and still more preferably, Tmw2 is higher by 15° C. or more and 35° C. or less. The roles of the plurality of waxes can be divided efficiently, and there is an effect to simultaneously achieve low-temperature fixability, high-temperature offset resistance and paper releasability. When the difference is smaller than 5° C., the effect to simultaneously achieve low-temperature fixability, high-temperature offset resistance and paper releasability is barely exhibited. When the difference is greater than 50° C., the first wax and the second wax undergo a phase separation, and they are not uniformly incorporated into the toner particles.

The preferable first wax contains at least one kind of an ester formed with at least a higher alcohol having 16 to 24 carbon atoms or a higher fatty acid having 16 to 24 carbon atoms. Due to the use of this wax, the presence of suspended particles resulting from the aliphatic hydrocarbon wax not being incorporated into the core particles is suppressed, the broadening of the particle size distribution of the core particles can be prevented, and the phenomenon in which the core particles rapidly become coarse when a shell is created can be prevented. In addition, low-temperature fixability can be enhanced. The use in combination with the second wax can enhance the high-temperature offset resistance and paper releasability, can prevent the particle size from being large, and enables the core particles that have a small particle size and a sharp particle size distribution to be prepared.

Preferable examples of alcohol components are, in addition to monoalcohols such as methyl, ethyl, propyl, butyl and the like, glycols such as ethylene glycol, propylene glycol and the like and multimers thereof, triols such as glycerol and multimers thereof, polyhydric alcohols such as pentaerythritol and the like, sorbitan, cholesterol, etc. When these alcohol components are polyhydric alcohols, the aforementioned higher fatty acids may be mono-substitutes or multi-substitutes.

Specifically, preferably examples are (i) esters formed with higher alcohols having 16 to 24 carbon atoms and higher fatty acids having 16 to 24 carbon atoms, such as stearyl stearate, palmityl palmitate, behenyl behenate, steary montanate and the like; (ii) esters formed with higher fatty acids having 16 to 24 carbon atoms and lower monoalcohols, such as butyl stearate, isobutyl behenate, propyl montanate, 2-ethylhexyl oleate and the like; (ii) esters formed with higher fatty acids having 16 to 24 carbon atoms and polyhydric alcohols, such as monoethylene glycol montanate, ethylene glycol distearate, monostearic acid glyceride, monobehenic acid glyceride, tripalmitin acid glyceride, pentaerythritol monobehenate, pentaerythritol dilinolate, pentaerythritol trioleate, pentaerythritol tetrastearate and the like; (iv) esters formed with higher fatty acids having 16 to 24 carbon atoms and polyhydric alcohol multimers, such as diethylene glycol monobehenate, diethylene glycol dibehenate, dipropylene glycol monostearate, distearic acid diglyceride, tetrastearic acid triglyceride, hexabehenic acid tetraglyceride, decastearic acid decaglyceride and the like; etc. These waxes may be used singly or in combination of two or more members.

When the number of carbon atoms of the alcohol component and/or the acid component is less than 16, the function as a dispersing aid is barely exhibited, and when it exceeds 24, the function as an auxiliary agent for low-temperature fixing barely is exhibited.

In addition, a wax having an iodine value of 25 or less and a saponification value of 30 to 300 is included as a preferable first wax. The use in combination with the second wax prevents the particle size from becoming large and enables the core particles of a small diameter having a narrow particle size distribution to be prepared. By specifying the iodine value, an effect to enhance the dispersion stability of the wax is obtained, and the core particle formation with the resin particles and the particles of colorant can progress uniformly, thereby enabling the core particles of a small diameter having a narrow particle size distribution to be prepared. Preferably, the iodine value is 20 or less and the saponification value of 30 to 200, and more preferably, the iodine value is 10 or less and the saponification value of 30 to 150.

On the contrary, when the iodine value is more than 25, the dispersion stability is excessively high, and the core particle formation with the resin particles and the particles of colorant cannot progress uniformly, showing a tendency of increased suspended particles of wax, and it is likely to result in coarse particles and a broad particle size distribution. When suspended particles remain in toner, the filming of the toner on a photoconductive member and the like occurs. This makes it difficult to relieve the repulsion caused by the charging action of the toner during multilayer transfer in the primary transfer process. When the saponification value is smaller than 30, the presence of unsaponifiable matter and hydrocarbons is increased, making is difficult to form uniform core particles of a small particle size, resulting in the filming of the toner on a photoconductive member or low chargeability, the chargeability of the toner is reduced during continuous use. When the saponification value is more than 300, suspended matter in the aqueous system is increased. Thus, the repulsion caused by the charging action of the toner is not likely to be relieved. Moreover, fogging or toner scattering may be increased.

The heating loss at 220° C. of the wax that has specific iodine and saponification values is preferably 8 wt. % or less. When the heating loss is greater than 8 wt. %, the glass transition point of the toner is decreased, impairing the storage stability of the toner. The development property are thus adversely affected, and fogging and photo conductor filming occur. The particle size distribution of the prepared toner is broad.

In the molecular weight characteristics of the wax that have specific iodine and saponification values based on gel permeation chromatography (GPC), it is preferable that the number-average molecular weight is 100 to 5000, the weight-average molecular weight is 200 to 10000, the ratio (weight-average molecular weight/number-average molecular weight) of the weight-average molecular weight to the number-average molecular weight is 1.01 to 8, the ratio (Z-average molecular weight/number-average molecular weight) of the Z-average molecular weight to the number-average molecular weight is 1.02 to 10, and there is at least one molecular weight peak maximum in the molecular weight range of 5×10² to 1×10⁴. It is more preferable that the number-average molecular weight is 500 to 4500, the weight-average molecular weight is 600 to 9000, the weight-average molecular weight/number-average molecular weight ratio is 1.01 to 7, and the Z-average molecular weight/number-average molecular weight ratio is 1.02 to 9. It is further preferable that the number-average molecular weight is 700 to 4000, the weight-average molecular weight is 800 to 8000, the weight-average molecular weight/number-average molecular weight ratio is 1.01 to 6, and the Z-average molecular weight/number-average molecular weight ratio is 1.02 to 8.

When the number-average molecular weight is less than 100, the weight-average molecular weight is less than 200, and the molecular weight peak maximum is in the range smaller than 5×10², the storage stability is impaired. Moreover, the handing property of the toner in a developing unit is reduced and impairs the uniformity of the toner concentration. The filming of the toner on a photoconductive member may occur. The particle size distribution of the prepared toner is broad.

When the number-average molecular weight is more than 5000, the weight-average molecular weight is more than 10000, the weight-average molecular weight/number-average molecular weight ratio (weight average molecular weight/number average molecular weight) is more than 8, the Z-average molecular weight/number-average molecular weight ratio (Z average molecular weight/number average molecular weight) is more than 10, and the molecular weight peak maximum is in the range larger than 1×10⁴, the releasing action is weak and low-temperature fixability is reduced, thereby making it difficult to make small the particle size of the prepared particles in the preparation of emulsified and dispersed particles of the wax.

Meadowfoam oil, carnauba wax, jojoba oil, Japan wax, yellow bees wax, ozokerite, carnauba wax, candellia wax, ceresin wax, rice wax and like materials are preferable as the first wax, and derivatives of these materials are also used preferably. And, it is possible to use these materials singly or in combination of two or more.

As meadowfoam derivatives, meadowfoam oil fatty acids, metal salts of meadowfoam oil fatty acids, meadowfoam oil fatty acid esters, hydrogenated meadowfoam oil and meadowfoam oil triesters can also be used preferably. An emulsified dispersion of particles of a small size having a uniform particle size distribution can be prepared. The examples given above are preferable materials with which effects to improve low-temperature fixability, to extend the developer life and to improve transferability in oilless fixing can be obtained. These can be used singly or in combination of two or more members.

The meadowfoam fatty acids obtained by subjecting meadowfoam oil to saponification decomposition are preferably those that are composed of fatty acids having 4 to 30 carbon atoms. As metal salts thereof, metal salts with sodium, potassium, calcium, magnesium, barium, zinc, lead, manganese, iron, nickel, cobalt, aluminium and the like can be used. The high-temperature offset resistance is good.

Examples of meadowfoam oil fatty acid esters are esters with methyl, ethyl, butyl, glycerol, pentaerythritol, polypropylene glycol, trimethylolpropane and the like, and in particular, meadowfoam oil fatty acid pentaerythritol monoester, meadowfoam oil fatty acid pentaerythritol triester, meadowfoam oil fatty acid trimethylolpropane ester and the like are preferable. These examples have an effect to enhance low-temperature fixability.

Hydrogenated meadowfoam oil is prepared by adding hydrogen to meadowfoam oil to turn unsaturated bonds into saturated bonds. The low-temperature fixability and glossiness thereby can be improved.

Moreover, isocyanate polymers of meadowfoam oil fatty acid polyhydric alcohol esters obtained by crosslinking the esterification reaction products of meadowfoam oil fatty acids and polyhydric alcohols such as glycerol, pentaerythritol, trimethylolpropane and the like with isocyanates such as tolylene diisocyanate (TDI), diphenylmethane-4,4′-diisocyanate (MDI) and the like can also be used preferably. Spenting of toner components on a carrier barely occurs, and it is thus possible to extend the life of a two-component developer.

Jojoba-oil fatty acids, metal salts of jojoba oil fatty acids, jojoba oil fatty acid esters, hydrogenated jojoba oil, jojoba oil triesters, maleic acid derivatives of epoxidized jojoba oil, isocyanate polymers of jojoba oil fatty acid polyhydric alcohol esters, and halogenated modified jojoba oils can also be preferably used as jojoba oil derivatives. An emulsified dispersion of particles that have a small particle size and a sharp particle size distribution can be prepared, and it is easy uniformly to disperse the resin and the wax concomitantly. The examples given above are preferable materials with which effects to improve low-temperature fixability, to extend the developer life and to improve transferability in oilless fixing can be obtained. These can be used singly or in combination of two or more members.

The jojoba oil fatty acids obtained by subjecting jojoba oil to saponification decomposition are preferably those that are composed of fatty acids having 4 to 30 carbon atoms. For metal salts thereof, metal salts with sodium, potassium, calcium, magnesium, barium, zinc, lead, manganese, iron, nickel, cobalt, aluminium and the like can be used. The high-temperature offset resistance is good.

Examples of jojoba oil fatty acid esters are esters with methyl, ethyl, butyl, glycerol, pentaerythritol, polypropylene glycol, trimethylolpropane and the like, and in particular, jojoba oil fatty acid pentaerythritol monoester, jojoba oil fatty acid pentaerythritol triester, jojoba oil fatty acid trimethylolpropane ester and the like are preferable. These examples have an effect of enhancing low-temperature fixability.

Hydrogenated jojoba oil is prepared by adding hydrogen to jojoba oil to turn unsaturated bonds into saturated bonds. The low-temperature fixability and glossiness can be improved.

Moreover, isocyanate polymers of jojoba oil fatty acid polyhydric alcohol esters obtained by crosslinking the esterification reaction products of jojoba oil fatty acids and polyhydric alcohols such as glycerol, pentaerythritol, trimethylolpropane and the like with isocyanates such as tolylene diisocyanate (TDI), diphenylmethane-4,4′-diisocyanate (MDI) and the like can also be used preferably. Spenting of toner components on a carrier barely occurs, and it is thus possible to extend the life of a two-component developer.

Saponification value refers to the amount expressed in milligram of potassium hydroxide necessary to saponify 1 g of a sample, and corresponds to the sum of acid value and ester value. To measure saponification value, a sample is saponified in an alcoholic solution of potassium hydroxide (about 0.5 N), and then potassium hydroxide in an excess is titrated with 0.5 N hydrochloric acid.

Iodine value refers to the amount of halogen absorbed by a sample measured while the halogen acts on the sample, and the amount of halogen absorbed is converted to iodine and expressed in grams per 100 g of the sample. The iodine value is expressed in grams of iodine absorbed, and the degree of unsaturation of fatty acid in the sample increases with the iodine value. A chloroform or carbon tetrachloride solution is prepared as a sample, and an alcohol solution of iodine and mercuric chloride or a glacial acetic acid solution of iodine chloride is added to the sample. After the sample is allowed to stand, the iodine that remains without causing any reaction is titrated with a sodium thiosulfate standard solution, and the amount of iodine absorbed is calculated.

Heating loss may be measured in the following manner. A sample cell is weighed precisely to the first decimal place (W₁ mg). Then, 10 to 15 mg of sample is placed in the sample cell and weighed precisely to the first decimal place (W₂ mg). This sample cell is set in a differential thermal balance and measured with a weighing sensitivity of 5 mg. After measurement, the weight loss (W₃ mg) of the sample at 220° C. is read to the first decimal place using a chart. The measuring device is, e.g., TGD-3000 (manufactured by ULVAC-RICO, Inc.), the rate of temperature rise is 10° C./min, the maximum temperature is 220° C., and the retention time is 1 min. Accordingly, the heating loss (%) can be determined by W₃/(W₂-W₁)×100.

The measurement of the endothermic peak temperature (melting point ° C.) by a DSC of the wax and the onset temperature may be carried out using Q100 manufactured by TA Instruments (a genuine electric refrigerator may be used for cooling), a “standard” measurement mode, and a purge gas (N2) at a flow rate of 50 ml/min. After power-on, the temperature in the measuring cell is set to 30° C., the apparatus is left to stand as is for 1 hour, the sample to be measured is introduced into the genuine aluminum pan in an amount of 10 mg±2 mg as sample quantity, and the aluminum pan containing the sample is introduced into the measuring instrument. Thereafter, the measuring instrument was retained at 5° C. for 5 min and heated at a rate of 1° C./min to 150° C. The “Universal Analysis Version 4.0” supplied with the instrument was used in the analysis. In the graph, the horizontal axis indicates the intracisternal temperature and the vertical axis indicates the heat flow. The temperature at which the endothermic curve starts to rise from the baseline is referred to the onset temperature, and the peak value of the endothermic curve is referred to as the endothermic peak temperature (melting point).

Materials such as hydroxystearic acid derivatives, glycerol fatty acid esters, glycol fatty acid esters and sorbitan fatty acid esters are preferably used in place of or in combination with the waxes mentioned above as the first wax. It is also effective to use these singly or in combination of two or more members. This enables a uniform emulsified dispersion of core particles of a small particle size to be prepared, and the use in combination with the second wax can prevent the particle size from becoming large and enables core particles that have a small particle size and a sharp particle size distribution to be formed.

Methyl 12-hydroxystearate, butyl 12-hydroxystearate, propylene glycol mono-12-hydroxystearate, glycerol mono-12-hydroxystearate, ethylene glycol mono-12-hydroxystearate and the like are preferable as hydroxystearic acid derivatives. They are preferable compounds with which effects to improve low-temperature fixability, to improve paper releasability and to prevent the filming of a photoconductive member in oilless fixing.

Glycerol stearate, glycerol distearate, glycerol tristearate, glycerol monopalmitate, glycerol dipalmitate, glycerol tripalmitate, glycerol behenate, glycerol dibehenate, glycerol tribehenate, glycerol monomyristate, glycerol dimyristate, glycerol trimyristate, and the like are preferable as glycerol fatty acid esters. These compounds have effects to ease a cold offset property at low temperatures and prevent transferability deterioration in oilless fixing.

Propylene glycol fatty acid esters such as propylene glycol monopalmitate, propylene glycol monostearate and the like; and ethylene glycol fatty acid esters such as ethylene glycol monostearate, ethylene glycol monopalmitate and the like are preferable as glycol fatty acid esters. These compounds have effects of improving low-temperature fixability, enhancing smoothness in development and thus preventing carrier spent.

Sorbitan monopalmitate, sorbitan monostearate, sorbitan tripalmitate, and sorbitan tristearate are preferable as sorbitan fatty acids esters. Further, pentaerythritol stearate, a mixed ester of adipic acid, stearic acid or oleic acid, and the like are preferable. These compounds can be used singly or in combination of two or more members. These compounds have effects to improve paper releasability and to prevent the filming of a photoconductive material in oilless fixing.

Fatty acid hydrocarbon waxes such as polypropylene wax, polyethylene wax, polypropylene polyethylene copolymer wax, microcrystalline wax, paraffin wax, Fischer-Tropsch wax and the like preferably can be used as the second wax.

The uniform inclusion of the wax in the resin without creating separated and suspended wax during mixed agglutination is influenced also by the distribution of the size of dispersed particles of the wax, the composition of the wax and the fusing characteristics of the wax.

The wax particle dispersion may be prepared in such a manner that the wax is introduced into an aqueous medium to which a surfactant has been added, and then heated, melted and dispersed.

The wax may be emulsified and dispersed so that the dispersed particle size of the wax is 20 to 200 nm for 16% diameter (PR16), 40 to 300 nm for 50% diameter (PR50), 400 nm or less for 84% diameter (PR84), and PR84/PR16 is 1.2 to 2.0 in a cumulative volume particle size distribution obtained by accumulation from the smaller particle size side. It is preferable that the particles having a diameter 200 nm or less is 65 vol. % or more, and the particles having a diameter of greater than 500 nm is 10 vol. % or less.

Preferably, the particle size is 20 to 100 nm for 16% diameter (PR16), 40 to 160 nm for 50% diameter (PR50) and 260 nm or less for 84% diameter (PR84), and PR84/PR16 is 1.2 to 1.8, in the cumulative volume particle size distribution obtained by accumulation from the smaller particle size side. It is preferable that the particles having a diameter of 150 nm or less is 65 vol. % or more, and the particles having a diameter greater than 400 nm is 10 vol. % or less.

More preferably, the particle size is 20 to 60 nm for 16% diameter (PR16), 40 to 120 nm for 50% diameter (PR50) and 220 nm or less for 84% diameter (PR84), and PR84/PR16 is 1.2 to 1.8, in the cumulative volume particle size distribution obtained by accumulation from the smaller particle size side. It is preferable that the particles having a diameter of 130 nm or less is 65 vol. % or more, and the particles having a diameter greater than 300 nm is 10 vol. % or less.

When the resin particle dispersion, the colorant particle dispersion and the wax particle dispersion are mixed to form aggregated core particles, the wax with a particle size of 20 to 200 nm for 50% diameter (PR50) can be dispersed finely and incorporated easily into the resin particles. Therefore, it is possible to prevent aggregation of the wax with each other, achieve uniform dispersion, and eliminate the suspended particles in the aqueous medium.

Moreover, when the aggregated particles are obtained by heating and melting the core particles in the aqueous medium, the molten particles of wax are covered with the molten resin particles due to surface tension, such that the molten resin particles wrap around the molten resin particles, so that the release agent can be incorporated easily into the resin.

When the particle size is more than 200 nm for PR16, more than 300 nm for 50% diameter (PR50), and more than 400 nm for PR84, PR84/PR16 is more than 2.0, the particles having a diameter of 200 nm or less are less than 65 vol. %, and the particles having a diameter greater than 500 nm are more than 10 vol. %, the wax is not incorporated easily into the resin particles and thus is prone to aggregation by itself. Therefore, a large number of particles that are not incorporated into the core particles are likely to be suspended in the water medium. When the core particles are obtained by heating and melting in the aqueous medium, the molten wax is not likely to be covered with the molten resin particles, so that the wax cannot be incorporated easily into the resin. Moreover, the amount of wax that is exposed on the surfaces of the aggregated particles and liberated therefrom on the surface of the toner base is increased while further resin particles are fused. This may increase the filming of the toner on a photoconductive member or spent of the toner on a carrier, reduce the handling property in developing, and cause a developing memory.

When the particle size is less than 20 nm for PR16 and less than 40 nm for 50% diameter (PR50), and PR84/PR16 is less than 1.2, it is difficult to maintain the dispersion state, and reaggregation of the wax occurs when it is left to stand, so that the standing stability of the particle size distribution can be impaired. Moreover, the load and the heat generation are increased when the particles are dispersed, thus reducing productivity.

A wax melt in which the wax is melted at a concentration of 40 wt. % or less is emulsified and dispersed in a medium that contains a dispersing agent and is maintained at a temperature at the melting point of the wax or higher using the effect of a strong shearing force generated when a rotating body rotates at high speed relative to a fixed body with a predetermined gap between them, thereby enabling the particles of wax to be dispersed finely.

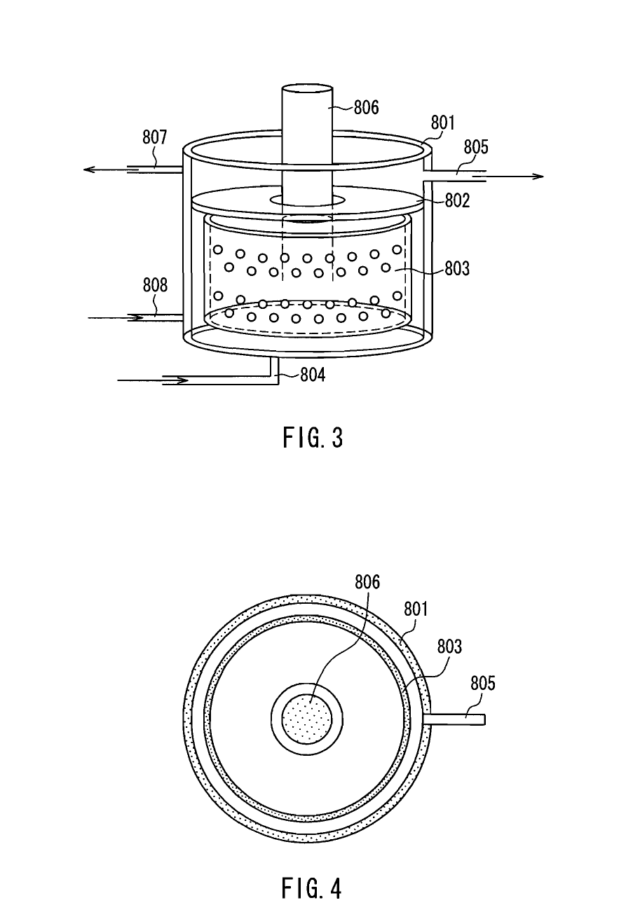

A gap of about 0.1 mm to about 10 mm is created on the tank wall inside a tank having a certain capacity as shown in FIGS. 3 and 4. The rotating body rotates at a high speed of 30 m/s or more, preferably 40 m/s or more, and more preferably 50 m/s or more and exerts a strong shearing force on the aqueous system, thus producing an emulsified dispersion of particles with a finer particle size. A 30-second to 5-minute treatment can create the dispersion.

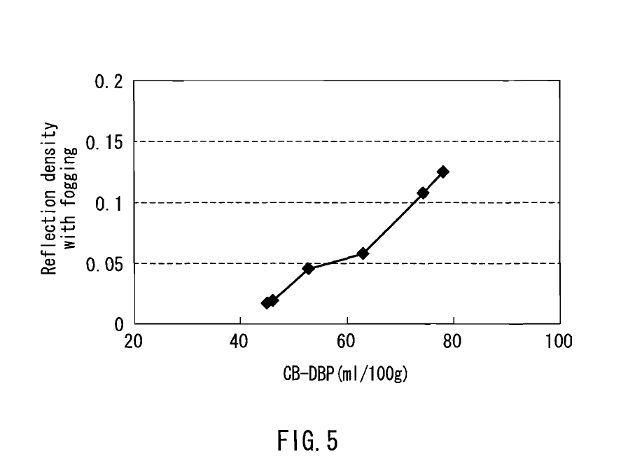

Moreover, as shown in FIGS. 5 and 6, a rotating body may rotate at a speed of 30 m/s or more, preferably 40 m/s or more, and more preferably 50 m/s or more relative to a fixed body while a gap of about 1 to about 100 μm is provided. This configuration also can create a strong shearing force, thus producing a fine dispersion.

In this manner, it is possible to form a narrower and sharper particle size distribution of the fine particles than using a dispersing device such as a homogenizer. It is also possible to maintain a stable dispersion state without causing any reaggregation of the fine particles in the dispersion even when left to stand for a long period of time. Thus, the standing stability of the particle size distribution can be improved.

When the wax has a high melting point, it may be heated under high pressure to form a melt. Alternatively, the wax may be dissolved in an oil-based solvent. This solution is blended with a surfactant or polyelectrolyte and dispersed in water to make a fine particle dispersion using a dispersing device as shown in FIGS. 3, 4, 5 and 6. Then, the oil-based solvent is evaporated optionally under reduced pressure.

The particle size can be measured using a laser diffraction particle size analyzer (LA920, manufactured by Horiba, Ltd.) a laser diffraction particle size analyzer (SALD2100, manufactured by Shimadzu Corporation) or the like.

(3) Resin

Examples of the fine resin particles of the toner of this embodiment are particles of thermoplastic binder resins. Specific examples include styrenes such as styrene, parachloro styrene, and α-methyl styrene and the like; acrylic monomers such as methyl acrylate, ethyl acrylate, n-propyl acrylate, lauryl acrylate, and 2-ethylhexyl acrylate and the like; methacrylic monomers such as methyl methacrylate, ethyl methacrylate, n-propyl methacrylate, lauryl methacrylate, 2-ethylhexyl methacrylate and the like; homopolymers of unsaturated polycarboxylic acid-based monomers having the carboxyl group of acrylic acid, methacrylic acid, maleic acid, fumaric acid or the like as a dissociable group; copolymers formed by combining two or more members of these monomers; and mixtures thereof.

Examples of polymerization initiators include azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobisisobutyronitrile and the like, persulfates (potassium persulfate, ammonium persulfate and the like), azo compounds such as 4,4′-azobis-4-cyanovaleric acid and salts thereof, 2,2′-azobis(2-amidinopropane) and salts thereof, peroxide compounds, and the like.

The amount of the resin particles in the resin particle dispersion is usually 5 to 50 wt. %, and preferably 10 to 40 wt. %.

To eliminate the suspended particles in the preparation of aggregated particles (sometimes referred to as core particles) by an aggregation reaction with the wax and the colorant and to prepare particles having a sharp particle size distribution, the glass transition point of the first resin particles that constitute the core particles is preferably 45° C. to 60° C. and the softening point is preferably 90° C. to 140° C. More preferably, the glass transition point is 45° C. to 55° C. and the softening point is 90° C. to 135° C., and still more preferably the glass transition point is 45° C. to 52° C. and the softening point is 90° C. to 130° C.

In addition, the first resin particles preferably have a weight-average molecular weight (Mw) of 10000 to 60000 and the ratio Mw/Mn of weight-average molecular weight (Mw) to number-average molecular weight (Mn) of 1.5 to 6. Preferably, the weight-average molecular weight (Mw) is 10000 to 50000, and the ratio Mw/Mn of weight-average molecular weight (Mw) to number-average molecular weight (Mn) is 1.5 to 3.9. More preferably, the weight-average molecular weight (Mw) is 10000 to 30000, and the ratio Mw/Mn of weight-average molecular weight (Mw) to number-average molecular weight (Mn) is 1.5 to 3.

By containing the first resin particles and the wax, coarsening of the core particles can be prevented, and particles having a narrow particle size distribution can be prepared efficiently. Moreover, there are effects that enable low temperature fixability to be attained, a change of the degree of image gloss according to the fixing temperature to be reduced, and image gloss to be made uniform. Usually, since an image gloss is increased as the fixing temperature is increased, temperature control during fixing needs to be performed precisely because the image gloss is changed according to the change of the fixing temperature. However, according to this embodiment, the effect to suppress the change of image gloss according to the change of fixing temperature can be obtained.

When the glass transition temperature of the first resin particles is less than 45° C., the core particles are coarse, and the storage stability and the heat resistance are low. When the glass transition temperature exceeds 60° C., the low temperature fixability is poor. When Mw is less than 10000, the core particles are coarse, and the storage stability and the heat resistance are low. When Mw exceeds 60000, the low temperature fixability is poor. When Mw/Mn exceeds 6, the shape of the core particles is not uniform and is likely to be irregular. Depressions and projections are created on the particle surface, and thus the particles are inferior in surface smoothness.

It is also preferable to form a resin fusion layer by fusing the second resin particles with the core particles. The resin preferably has a glass transition point of 55° C. to 75° C., a softening point of 140° C. to 180° C., a weight-average molecular weight (Mw) measured by gel permeation chromatography (GPC) of 50000 to 500000 and the ratio of Mw/Mn (weight-average molecular weight (Mw) to number-average molecular weight (Mn)) of 2 to 10. More preferably, the glass transition point is 60° C. to 70° C., the softening point is 145° C. to 180° C., Mw is 80000 to 500000, and Mw/Mn is 2 to 7. Still more preferably, the glass transition point is 65° C. to 70° C., the softening point is 150° C. to 180° C., Mw is 120000 to 500000, and Mw/Mn is 2 to 5.

The purpose is to enhance durability, high-temperature offset resistance and releasability by promoting the thermal adhesion at the surface of the core particles and setting a relatively high softening point. When the glass transition point of the second resin particles is less than 55° C., secondary aggregation is likely to occur, and the storage stability is poor. When the glass transition point of the second resin particles exceeds 75° C., the thermal adhesiveness to the surface of the core particles is poor, and uniform adherability is low. When the softening point of the second resin particles is less than 140° C., durability, high-temperature offset resistance and releasability are low. When the softening point exceeds 180° C., glossiness and transmittance are low. By making Mw/Mn small to bring the molecular weight distribution close to that of monodispersion, the thermal adhesion of the second resin particles with the surface of the core particles can be carried out uniformly. When the Mw of the second resin particles is less than 50000, durability, high-temperature offset resistance and paper releasability are low. When the Mw of the second resin particles is more than 500000, low-temperature fixability, glossiness, and transmittance are low.

In addition, the proportion of the first resin particles is preferably 60 wt. % or more, more preferably 70 wt. % or more and still more preferably 80 wt. % or more based on the entire toner resin.

The molecular weights of the resin, wax and toner can be measured by gel permeation chromatography (GPC) using several types of monodisperse polystyrene as standard samples.

The measurement may be performed with HLC 8120 GPC series manufactured by TOSOH CORP., using TSK gel super HM-H H4000/H3000/H2000 (6.0 mm I.D., 150 mm×3) as a column and THF (tetrahydrofuran) as an eluant, at a flow rate of 0.6 ml/min, a sample concentration of 0.1%, an injection amount of 20 mL, RI as a detector, and at a temperature of 40° C. Prior to the measurement, the sample is dissolved in THF and then filtered using a 0.45 μm membrane filter so that additives such as silica are removed to measure the resin component. The measurement requirement is that the molecular weight distribution of the subject sample is in the range where the logarithms and the count numbers of the molecular weights in the analytical curve obtained from the several types of monodisperse polystyrene standard samples form a straight line.

The wax obtained by the reaction of a long-chain alkyl alcohol, an unsaturated polycarboxylic acid or an anhydride thereof, and a synthetic hydrocarbon wax can be measured with GPC-150C (manufactured by Waters Corporation), using Shodex HT806M (8.0 mm I.D., 30 cm×2) as a column and o-dichlorobenzene as an eluant, at a flow rate of 1.0 mL/min, a sample concentration of 0.3%, an injection amount of 200 μL, RI as a detector, and at a temperature of 130° C. Prior to the measurement, the sample is dissolved in a solvent and then filtered using a 0.5 μm sintered metal filter. The measurement requirement is that the molecular weight distribution of the subject sample is in the range where the logarithms and the count numbers of the molecular weights in the analytical curve obtained from the several types of monodisperse polystyrene standard samples form a straight line.

The softening point of the binder resin can be measured with a capillary rheometer flow tester (CFT-500, constant-pressure extrusion system, manufactured by Shimadzu Corporation). A load of about 9.8×10⁵ N/m² is applied to a 1 cm³ sample with a plunger while heating the sample at a temperature increase rate of 6° C./min, so that the sample is extruded from a die having a diameter of 1 mm and a length of 1 mm. Based on the relationship between the piston stroke of the plunger and the temperature increase characteristics, when the temperature at which the piston stroke starts to rise is a flow start temperature (Tfb), one-half the difference between the minimum value of a curve of the piston stroke characteristics and the flow end point is determined. Then, the resultant value and the minimum value of the curve are added to define a point, and the temperature of this point is identified as a melting point (softening point: Ts ° C.) according to the ½ method.

The glass transition point of the resin can be measured using a differential scanning calorimeter (DSC-50 manufactured by Shimadzu Corporation). The temperature of a sample is raised to 100° C., retained for 3 minutes, and reduced to room temperature at 10° C./min. Subsequently, the temperature of the cooled sample is raised at 10° C./min, and the thermal history of the sample is measured. In the thermal history, an intersection point of an extension line of the base line lower than the glass transition point and a tangent that shows the maximum inclination between the rising point and the highest point of a peak is determined.

(4) Pigment

Carbon black is used as a black pigment of the colorant (pigment) for use in this embodiment. As stated above, the DBP oil absorption of the carbon black is 45 to 70 (ml/100 g). For example, #52 (particle size: 27 nm, DBP oil absorption: 63 ml/100 g), #50 (particle size: 28 nm, DBP oil absorption: 65 ml/100 g), #47 (particle size: 23 nm, DBP oil absorption: 64 ml/100 g), #45 (particle size: 24 nm, DBP oil absorption: 53 ml/100 g) and #45L (particle size: 24 nm, DBP oil absorption: 45 ml/100 g) all manufactured by Mitsubishi Chemical Corporation; and REGAL 250R (particle size: 35 nm, DBP oil absorption: 46 ml/100 g), REGAL 330R (particle size: 25 nm, DBP oil absorption: 65 ml/100 g) and MOGULL (particle size: 24 nm, DBP oil absorption: 60 ml/100 g) all manufactured by Cabot Corporation are preferable materials. #45, #45 and LREGAL 250R are particularly preferable.

DBP oil absorption quantitatively represents the state of chain-like aggregation (structure) of the particles, and the structure is expressed by the primary structure by chemical bonding and the secondary structure by physical bonding by Van der Waals force.

The measurement of DBP oil absorption (JIS K6217) may be carried out by introducing 20 g of a sample (Ag) dried at 150° C.±1° C. for 1 hour into the mixing chamber of an absorptmeter (manufactured by Brabender Instruments Inc., spring tension: 2.68 kg/cm), and after setting the limit switch to about 70% of the maximum torque, the mixer is rotated. Simultaneously, DBP (specific gravity: 1.045 to 1.050 g/cm³) is added at a rate of 4 ml/min from an automatic buret. Reaching nearly the end point, torque is increased rapidly and the limit switch is activated. The DBP oil absorption per 100 g sample (=B×100/A) (ml/100 g) can be calculated from the amount of DBP added by then (B ml) and the weight of the sample.

Examples of pigments for use as color toners include acetoacetic acid aryl amide monoazo yellow pigments such as C.I. Pigment Yellow 1, 3, 74, 97 and 98, acetoacetic acid aryl amide disazo yellow pigments such as C.I. Pigment Yellow 12, 13, 14 and 17, C.I. Solvent Yellow 19, 77 and 79, or C.I. Disperse Yellow 164. In particular, benzimidazolone pigments of C.I. Pigment Yellow 93, 180 and 185 are preferable.

Red pigments such as C.I. Pigment Red 48, 49:1, 53:1, 57, 57:1, 81, 122, 5 and the like and red dyes such as C.I. Solvent Red 49, 52, 58, 8 and the like can be used preferably as magenta pigments.

Blue dyes/pigments of phthalocyanine and derivatives thereof such as C.I. Pigment Blue 15:3 can be used as cyan pigments. The amount of cyan pigment to be added is preferably 3 to 8 parts by weight per 100 parts by weight of the binder resin.

Here, the particle size refers to the arithmetic mean diameter by an SEM electron microscope. Carbon black having a particle size of 20 to 40 nm is preferable. More preferably, the particle size is 20 to 35 nm. The coloring power is likely to be low when the particle size is large. It tends to be difficult to disperse the particles in the fluid when the particle size is small.

(5) Additives

In this embodiment, fine inorganic particles are admixed as an additive. Examples of the additive used include fine metal oxide powder such as silica, alumina, titanium oxide, zirconia, magnesia, ferrite, magnetite and the like; titanates such as barium titanate, calcium titanate, strontium titanate and the like; zirconates such as barium zirconate, calcium zirconate, strontium zirconate and the like, and mixtures thereof. The additive can be made hydrophobic as needed.

Examples of silicone oil materials used to treat the additive include dimethyl silicone oil, methyl hydrogen silicone oil, methyl phenyl silicone oil, epoxy modified silicone oil, carboxyl modified silicone oil, methacrylic modified silicone oil, alkyl modified silicone oil, fluorine modified silicone oil, amino modified silicone oil, and chlorophenyl modified silicone oil. The additive that is treated with at least one of the above silicone oil materials is used preferably, for example, SH200, SH510, SF230, SH203, BY16-823 and BY16-855B manufactured by Toray-Dow Corning Co., Ltd.

The treatment may be performed according to a method in which the additive and a silicone oil material are mixed using a mixer such as a Henshel mixer (FM20B, manufactured by Mitsui Mining Co., Ltd.), a method in which a silicone oil material is sprayed onto the additive, a method in which a silicone oil material is dissolved or dispersed in a solvent, and mixed with the additive, followed by removal of the solvent, and like methods. The amount of silicone oil material is preferably 1 to 20 parts by weight per 100 parts by weight of the additive.

Examples of preferably usable silane coupling agents include dimethyldichlorosilane, trimethylchlorosilane, allyldimethylchlorosilane, hexamethyldisilazane, allylphenyldichlorosilane, vinyltriethoxysilane, divinylchlorosilane, dimethylvinylchlorosilane, etc. The silane coupling agents may be treated by a dry treatment in which the additive is fluidized by agitation or the like and an evaporated silane coupling agent is reacted with the fluidized powder, a wet treatment in which a silane coupling agent dispersed in a solvent is added dropwise to the additive for reaction, or like treatments.

It is also preferable that the silicone oil material is treated after the silane coupling treatment.

The additive that has positive chargeability may be treated with aminosilane, amino modified silicone oil or epoxy modified silicone oil.

To enhance a hydrophobic treatment, hexamethyldisilazane, dimethyldichlorosilane, or other silicone oil can be also used along with the above materials. For example, at least one member selected from dimethyl silicone oil, methylphenyl silicone oil and alkyl modified silicone oil is preferable for treatment.

Moreover, it is preferable to treat the surface of the additive with at least one or more members selected from fatty acid esters, fatty acid amides, fatty acids and fatty acid metal salts (hereinafter, fatty acids or the like). Surface-treated fine particles of silica or titanium oxide are more preferable.

Examples of fatty acids and fatty acid metal salts include caprylic acid, capric acid, undecylic acid, lauric acid, myristic acid, palmitic acid, stearic acid, behenic acid, montanic acid, lacceric acid, oleic acid, erucic acid, sorbic acid, linoleic acid and the like. In particular, fatty acids having 12 to 22 carbon atoms are preferable.

Metals of fatty acid metal salts may be aluminum, zinc, calcium, magnesium, lithium, sodium, lead and barium. Among these metals, aluminum, zinc and sodium are preferable. Further, di-fatty acid aluminum such as aluminum distearate (Al(OH)(C₁₇H₃₅COO)₂) and the like and mono-fatty acid aluminum such as aluminum monostearate (Al(OH)₂(C₁₇H₃₅COO)) and the like are particularly preferable. By having a hydroxy group, they can prevent overcharge and suppress a transfer failure. Moreover, it is presumed that the treatability with the additive is enhanced.

Palmitic acid amide, palmitoleic acid amide, stearic acid amide, oleic acid amide, arachidic acid amide, eicosanoic acid amide, behenic acid amide, erucic acid amide, lignoceric acid amide and like saturated or univalent unsaturated aliphatic amides having 16 to 24 carbon numbers are preferably used as aliphatic amides.

Esters formed with higher alcohols having 16 to 24 carbon atoms and higher fatty acids having 16 to 24 carbon atoms such as stearyl stearate, palmityl palmitate, behenyl behenate, steary montanate and the like, esters formed with higher fatty acids having 16 to 24 carbon atoms and lower monoalcohols such as butyl stearate, isobutyl behenate, propyl montanate, 2-ethylhexyl oleate and the like, fatty acid pentaerythritol monoesters, fatty acid pentaerythritol triesters, fatty acid trimethylolpropane esters and the like can be preferably used as fatty acid esters.

Materials such as hydroxystearic acid derivatives, glycerol fatty acid esters, glycol fatty acid esters, sorbitan fatty acid esters, and like polyhydric alcohol fatty acid esters are preferable, and these materials can be used singly or in combination of two or more members.

As a preferable mode of surface treatment, treating the surface of the additive with a coupling agent and/or polysiloxane such as silicone oil, and then with a fatty acid is preferable. Thus, a more uniform treatment can be performed than a treatment in which hydrophilic silica is treated merely with a fatty acid, thereby giving effects to provide a toner with high chargeability and to enhance the fluidity when added to the toner. The aforementioned effects can be obtained also by a treatment with a fatty acid or the like in conjunction with a coupling agent and/or silicone oil.

A surface-treated additive may be prepared by dissolving a fatty acid or the like in a hydrocarbon organic solvent such as toluene, xylene, hexane or the like; introducing into a disperser for wet-blend the solution and the additive such as silica, titanium oxide, alumina or the like, thereby adhering the fatty acid or the like to the surface of the additive, i.e., surface treatment; and carrying out a drying treatment to remove the solvent by evaporation.

It is preferable that the mixing ratio of polysiloxane to fatty acid or the like is 1:2 to 20:1. When the proportion of fatty acid or the like is higher than 1:2, the charge amount of the additive is high, and thus the image density is likely to be low, and in a two-component development, charge-up is likely to occur. When the proportion of fatty acid or the like is smaller than 20:1, the effect against transfer void and reverse transfer during transfer is low.

At this time, the ignition loss of the additive that has undergone a surface treatment with the fatty acid or the like is preferably 1.5 to 25 wt. %, more preferably 5 to 25 wt. %, and still more preferably 8 to 20 wt. %. When the ignition loss is less than 1.5 wt. %, the treatment agent does not function sufficiently, not exhibiting the effect to enhance the chargeability and transferability. When the ignition loss is more than 25 wt. %, part of the treatment agent remains unused and adversely affects the developability and durability.

Since the surface of the toner base particles prepared according to the present invention is smooth and uniform unlike that of the toner base particles prepared according to the conventional pulverization method and the surface is composed mostly of only a resin, the present invention is advantageous in terms of charging uniformity. This is because the compatibility with the additive for use is important with respect to chargeability and charge retention.

It is preferable that 1 to 6 parts by weight of the additive having an average particle size of 6 nm to 200 nm is added to 100 parts by weight of the toner base particles. When the average particle size is less than 6 nm, it is likely that suspended particles are generated and filming on a photoconductive member occurs. Therefore, it is difficult to completely prevent reverse transfer. When the average particle size is more than 200 nm, the flowability of the toner is poor. When the amount of the additive is less than 1 part by weight, the flowability of the toner is poor, and it is difficult to prevent reverse transfer completely. When the amount of the additive is more than 6 parts by weight, it is likely that suspended particles are generated and filming on a photoconductive member occurs, thus degrading the high-temperature offset resistance.

Moreover, it is preferable that 0.5 to 2.5 parts by weight of the additive having an average particle size of 6 nm to 20 nm, and 0.5 to 3.5 parts by weight of the additive having an average particle size of 20 nm to 200 nm are added to 100 parts by weight of the toner base particles. With this configuration, due to the use of the additives that have different functions, the chargeability and the charge retainability can be enhanced, and larger margins against reverse transfer, transfer void and toner scattering during transfer can be ensured. In this case, the ignition loss of the additive having an average particle size of 6 nm to 20 nm is preferably 0.5 to 20 wt. %, and the ignition loss of the additive having a mean particle size of 20 nm to 200 nm is preferably 1.5 to 25 wt. %. By arranging the ignition loss of the additive having an average particle size of 20 nm to 200 nm to be greater than that of the additive having an average particle size of 6 nm to 20 nm, an effect for charge retainability and an effect against reverse transfer and transfer void during transfer can be obtained.

By specifying the ignition loss of the additive, larger margins can be ensured against reverse transfer, transfer void and scattering during transfer, and the handleability of the toner in a development unit can be improved, thus increasing the uniformity of the toner concentration.

When the ignition loss of the additive having an average particle size of 6 nm to 20 nm is less than 0.5 wt. %, the margins against reverse transfer and transfer void are narrow. When the ignition loss is more than 20 wt. %, the surface treatment is not uniform, resulting in charge variations. The ignition loss is preferably 1.5 to 17 wt. %, and more preferably 4 to 10 wt. %.

When the ignition loss of the additive having an average particle size of 20 nm to 200 nm is less than 1.5 wt. %, the margins against reverse transfer and transfer void are narrow. When the ignition loss is more than 25 wt. %, the surface treatment is not uniform, resulting in charge variations. The ignition loss is preferably 2.5 to 20 wt. %, and more preferably 5 to 15 wt. %.

Moreover, it is also preferable that 0.5 to 2 parts by weight of the additive having an average particle size of 6 nm to 20 nm and an ignition loss of 0.5 to 20 wt. %, 0.5 to 3.5 parts by weight of the additive having an average particle size of 20 nm to 100 nm and an ignition loss of 1.5 to 25 wt. %, and 0.5 to 2.5 parts by weight of the additive having an average particle size of 100 nm to 200 nm and an ignition loss of 0.1 to 10 wt. % are added to 100 parts by weight of the toner base particles. Due to the additives that have different functions and that have specific average particle sizes and ignition losses, effects to enhance the chargeability and charge retainability, to reduce reverse transfer and transfer void during transfer, and to remove contaminants adhered to the surface of a carrier.

Furthermore, it is also preferable that 0.2 to 1.5 parts by weight of a positively charged additive having an average particle size of 6 nm to 200 nm and an ignition loss of 0.5 to 25 wt. % is further added to 100 parts by weight of toner base particles.

The addition of a positively charged additive can suppress the overcharge of the toner occurring due to the continuous use for a long period of time and extend the life of a developer. Therefore, the scattering of the toner during transfer caused by overcharge also can be suppressed. Moreover, it is possible to prevent spent on a carrier. When the amount of positively charged additive is less than 0.2 parts by weight, these effects are not likely to be obtained. When the amount of positively charged additive is more than 1.5 parts by weight, fogging is increased during development. The ignition loss is preferably 1.5 to 20 wt. % and more preferably 5 to 19 wt. %.

Average particle size may be expressed as a value obtained by calculating the average of the length of the longer axis and the shorter axis of about 100 particles using magnified photographs taken by an SEM.

Drying loss (%) may be determined in the following manner. A container is dried, allowed to stand and cool, and weighed precisely in advance. Then, a sample of about 1 g is placed in the container, weighed precisely, and dried for 2 hours with a hot-air dryer at 105° C.±1° C. After cooling for 30 minutes in a desiccator, the weight is measured, and the drying loss is calculated using the following formula.

Drying loss (%)=(weight loss (g) by drying/sample amount (g))×100

Ignition loss may be determined in the following manner. A magnetic crucible is dried, allowed to stand and cool, and weighed precisely in advance. Then, a sample (about 1 g) is placed in the crucible, weighed precisely, and ignited for 2 hours in an electric furnace at 500° C. After cooling for 1 hour in a desiccator, the weight is measured, and the ignition loss is calculated using the following formula.

Ignition loss (%)=(weight loss (g) by ignition/sample amount (g))×100

The amount of moisture absorption of the surface-treated additive is preferably 1 wt. % or less, more preferably 0.5 wt. % or less, still more preferably 0.1 wt. % or less, and even more preferably 0.05 wt. % or less. When the amount of moisture absorption is more than 1 wt. %, the chargeability is low, and filming of the toner on a photoconductive member occurs. The amount of moisture absorption may be measured using a continuous vapor absorption measuring device (BELSORP 18, manufactured by BEL Japan, Inc.).

The degree of hydrophobicity may be determined in the following manner using methanol titration. A sample (0.2 g) is weighed in a 250 ml beaker containing 50 ml of distilled water. Then, methanol is added from a buret, the end thereof is immersed in the water, until the entire additive is wet while continuing stirring slowly using a magnetic stirrer. Based on the amount “a” (ml) of methanol required to wet the additive completely, the degree of hydrophobicity is calculated using the following formula.

Degree of hydrophobicity (%)=(a/(50+a))×100

(6) Physical Characteristics of Toner Powder

In this embodiment, it is preferable that toner base particles containing a binder resin, a colorant and a wax have a volume-average particle size of 3 to 7 μm; the content of the toner base particles having a particle size of 2.52 to 4 μm in a number distribution is 10 to 75% by number; the toner base particles having a particle size of 4 to 6.06 μm in a volume distribution is 25 to 75% by volume; the toner base particles having a particle size of 8 μm or more in the volume distribution is 5% by volume or less; P46/V46 is in the range of 0.5 to 1.5 where V46 is the volume percentage of the toner base particles having a particle size of 4 to 6.06 μm in the volume distribution and P46 is the number percentage of the toner base particles having a particle size of 4 to 6.06 μm in the number distribution; the coefficient of variation in the volume-average particle size is 10 to 25%; and the coefficient of variation in the number particle size distribution is 10 to 28%.

More preferably, the toner base particles have a volume-average particle size of 3 to 6.5 μm, the content of the toner base particles having a particle size of 2.52 to 4 μm in the number distribution is 20 to 75% by number, the toner base particles having a particle size of 4 to 6.06 μm in the volume distribution is 35 to 75% by volume, the toner base particles having a particle size of 8 μm or more in the volume distribution is 3% by volume or less, P46/V46 is in the range of 0.5 to 1.3, the coefficient of variation in the volume-average particle size is 10 to 20%, and the coefficient of variation in the number particle size distribution is 10 to 23%.

Further preferably, the toner base particles have a volume-average particle size of 3 to 5 μm, the content of the toner base particles having a particle size of 2.52 to 4 μm in the number distribution is 40 to 75% by number, the toner base particles having a particle size of 4 to 6.06 μm in the volume distribution is 45 to 75% by volume, the toner base particles having a particle size of 8 μm or more in the volume distribution is 1% or less by volume, P46/V46 is in the range of 0.5 to 0.9, the coefficient of variation in the volume-average particle size is 10 to 15%, and the coefficient of variation in the number particle size distribution is 10 to 18%.

The toner base particles with the above-described characteristics can provide high-resolution image quality, prevent reverse transfer and transfer void during tandem transfer, and achieve oilless fixing. The fine powder in the toner affects the flowability, image quality and storage stability of the toner, the filming of the toner on a photoconductive member, a developing roller or a transfer member, the aging property, the transferability, and particularly the multilayer transferability in a tandem system. The fine powder also affects the offset resistance, glossiness and transmittance in oilless fixing. When the toner contains a wax or the like to achieve oilless fixing, the amount of fine powder affects compatibility between oilless fixing and tandem transferability.

When the volume-average particle size exceeds 7 μm, the image quality and the transferability cannot be attained simultaneously. When the volume-average particle size is less than 3 μm, the handleability of the toner particles in development is poor.

When the content of the toner base particles having a particle size of 2.52 to 4 μm in the number distribution is less than 10% by number, the image quality and the transferability cannot be attained simultaneously. When the content is more than 75% by number, the handleability of the toner particles in development is poor. Moreover, the filming of the toner on a photoconductive member, a developing roller or a transfer member is likely to occur. The adhesion of the fine powder to a heat roller is strong and thus tends to cause offset. In a tandem system, the aggregation of the toner is likely to be stronger, readily resulting in a transfer failure of the second color during multilayer transfer. Therefore, the content needs to be in an appropriate range.

When the content of toner base particles having a particles size of 4 to 6.06 μm in the volume distribution is more than 75% by volume, the image quality and the transferability cannot be attained simultaneously. When it is less than 25% by volume, the image quality is poor.

When the content of the toner base particles having a particle size of 8 μm or more in the volume distribution is more than 5% by volume, the image quality is poor, resulting in a transfer failure.

When P46/V46 (where V46 is the volume percentage of the toner base particles having a particle size of 4 to 6.06 μm in the volume distribution and P46 is the number percentage of the toner base particles having a particle size of 4 to 6.06 μm in the number distribution) is less than 0.5, the amount of fine powder is increased excessively, so that the flowability and the transferability are reduced, and background fogging occurs severely. When P46/V46 is more than 1.5, large particles are present in large amounts, and the particle size distribution is broad. Thus, high image quality cannot be achieved.

The purpose of specifying P46/V46 is to provide an index for the reduction of the size of the toner particles and thus narrowing the particle size distribution thereof.

The coefficient of variation can be obtained by dividing the standard deviation by the average particle size of the toner particles based on the particle size measured using a Coulter Counter (manufactured by Coulter Electronics, Inc.). When the particle sizes of n particles are measured, the standard deviation can be expressed by the square root of the value that is obtained by dividing the square of the difference between each of the n measured values and the mean value by (n−1).

In other words, the coefficient of variation indicates the degree of expansion of the particle size distribution. When the coefficient of variation of the volume particle size distribution or the number particle size distribution is less than 10%, productivity is low, resulting in high costs. When the coefficient of variation of the volume particle size distribution is more than 25%, or when the coefficient of variation of the number particle size distribution is more than 28%, the particle size distribution is broad, and the aggregation of toner is strong, resulting in the filming of the toner on a photoconductive member and a transfer failure and making it difficult to collect the residual toner in a cleanerless process.

The particle size distribution may be measured using a Coulter Counter TA-II (manufactured by Coulter Electronics, Inc.). An interface (manufactured by Nikkaki Bios Co., Ltd.) that outputs a number distribution and a volume distribution and a personal computer are connected to the Coulter Counter TA-II. An electrolytic solution (about 50 ml) is prepared by introducing a surfactant (sodium lauryl sulfate) so as to have a concentration of 1%. About 2 mg of toner to be measured is added to the electrolytic solution. This electrolytic solution in which the sample is suspended is dispersed for about 3 minutes with an ultrasonic dispersing device, and then is measured using the 70 μm aperture of the Coulter Counter TA-II. In the 70 μm aperture system, the measurement range of the particle size distribution is 1.26 μm to 50.8 μm. However, the region smaller than 2.0 μm is not suitable for practical use because the measurement accuracy or reproducibility is low due to the influence of external noise or the like. Therefore, the measurement range is set from 2.0 μm to 50.8 μm.

The degree of compression, which is calculated from static bulk density and dynamic bulk density, is an index of toner fluidity. The fluidity of toner is affected by the particle size distribution, particle shape of the toner, and the type and amount of the additive and the wax. The degree of compression is low and the toner fluidity is high when the particle size distribution of the toner is narrow and there is little micropowder, when there are few depressions and projections on the surface of the toner and the particle shape is close to spherical, when a large amount of the additive is added, or when the particle size of the additive is small. The degree of compression is preferably 5 to 40% and more preferably 10 to 30%, thereby allowing both oilless fixing and tandem multilayer transfer to be achieved. When the degree of compression is less than 5%, fixability tends to be low and transmittance in particular tends to be poor. In addition, the toner tends to be scattered from the developing roller. When the degree of compression is greater than 40%, transferability is low, resulting in places of no toner transfer and a transfer failure in tandem transfer.

(7) Oilless Color Fixing

The toner of this embodiment can be used preferably in an electrographic apparatus having a fixing process with an oilless fixing configuration that applies no oil to any fixing means. As a heating means, electromagnetic induction heating is suitable in view of reducing a warm-up time and power consumption. The oilless fixing configuration includes a magnetic field generation means and a heating and pressing means. The heating and pressing means includes a rotational heating member and a rotational pressing member. The rotational heating member includes at least a heat generation layer that generates heat by electromagnetic induction and a release layer. There is a certain nip between the rotational heating member and the rotational pressing member. The toner that has been transferred to a transfer medium such as copy paper is fixed by passing the transfer medium between the rotational heating member and the rotational pressing member. This configuration is characterized by the warm-up time of the rotational heating member that has a quick rising property as compared with a conventional configuration using a halogen lamp. Therefore, the copying operation starts before the temperature of the rotational pressing member is raised sufficiently. Thus, the toner is required to have low-temperature fixability and a wide range of offset resistance.

Another configuration in which a heating member is separated from a fixing member and a fixing belt runs between the two members also may be used preferably. The fixing belt may be, e.g., a nickel electroformed belt having heat resistance and deformability or a heat-resistant polyimide belt. Silicone rubber, fluorocarbon rubber, or fluorocarbon resin may be used as a surface coating to improve releasability.

In the conventional fixing process, release oil is applied to prevent offset. The toner that exhibits releasability without using oil can eliminate the need for application of the release oil. However, if the release oil is not applied to the fixing means, it can be charged easily. Therefore, when an unfixed toner image is close to the heating member or the fixing member, the toner may be scattered due to the influence of charge. Such scattering is likely to occur particularly under low temperature and low humidity.

In contrast, the toner of this embodiment can achieve low-temperature fixability and a wide range of offset resistance without using oil. The toner also can provide high color transmittance. Thus, the use of the toner of this embodiment can suppress overcharge as well as scattering caused by the charging action of the heating member or the fixing member.

(8) Tandem Color Process

This embodiment employs the following transfer process for high-speed color image formation. A plurality of toner image forming stations, each of which contains a photoconductive member, a charging member and a toner support member, are used. In a primary transfer process, a toner image created by making an electrostatic latent image formed on an image support member visible, and the toner image is transferred to an endless transfer member that is in contact with the photoconductive member. The primary transfer process is performed continuously in sequence so that a multilayer toner image is formed on the transfer member. Then, a secondary transfer process is performed by collectively transferring the multilayer toner image from the transfer member to a transfer medium such as paper or OHP sheet. The transfer process satisfies the relationship expressed by d1/v≦0.65 where d1 (mm) is a distance between the first primary transfer position and the second primary transfer position, and v (mm/s) is a circumferential velocity of the photoconductive member. This configuration can reduce the machine size and improve the printing speed. To process at least 20 sheets (A4) per minute and to make the size small enough to be used for SOHO (small office/home office) purposes, a distance between the toner image forming stations should be as short as possible while the processing speed should be enhanced. Thus, d1/v≦0.65 is considered as the minimum requirement to achieve both small size and high printing speed.

However, when the distance between the toner image forming stations is too short, e.g., when a period of time from the primary transfer of the first color (yellow toner) to that of the second color (magenta toner) is extremely short, the charge of the transfer member or the charge of the transferred toner hardly is relieved. Therefore, when the magenta toner is transferred onto the yellow toner, it is repelled by the charging action of the yellow toner. This may lead to lower transfer efficiency and transfer void. When the third color (cyan) toner is transferred onto the yellow toner and the magenta toner, the cyan toner may be scattered to cause a transfer failure or considerable transfer void. Moreover, toner having a specific particle size is developed selectively with repeated use, and the individual toner particles differ significantly in flowability, so that frictional charge opportunities are different. Thus, the charge amount is varied and further reduces the transfer property.

In such a case, therefore, the toner or two-component developer of this embodiment can be used to stabilize the charge distribution and suppress the overcharge and flowability variations. Accordingly, it is possible to prevent a reduction of transfer efficiency, transfer void and reverse transfer without sacrificing the fixability.

### EXAMPLES

### (1) Example of Carrier Production

MnO (39.7 mol %), MgO (9.9 mol %), Fe₂O₃ (49.6 mol %) and SrO (0.8 mol %) were placed in a wet ball mill and then were pulverized for 10 hours and mixed. The resultant mixture was dried, kept at 950° C. for 4 hours, and temporarily calcined. The resultant was pulverized for 24 hours in a wet ball mill, and then was granulated and dried by a spray dryer. The granulated material was kept in an electric furnace at 1270° C. for 6 hours in an atmosphere having an oxygen concentration of 2%, and fully calcined. The calcined material was ground and further classified, thus producing a core material of ferrite particles that had an average particle size of 50 μm and a saturation magnetization of 65 emu/g in an applied magnetic field of 3000 oersted.

Next, 250 g of polyorganosiloxane represented by Formula (1) in which R¹ and R² are methyl groups, i.e., (CH₃)₂SiO_{2/2} unit is 15.4 mol % and Formula (2) in which R³ is a methyl group, i.e., CH₃SiO_{3/2} unit is 84.6 mol % was reacted with 21 g of CF₃CH₂CH₂Si(OCH₃)₃ to produce a fluorine-modified silicone resin. Then, 100 g of the fluorine-modified silicone resin (solid content) and 10 g of aminosilane coupling agent (γ-aminopropyltriethoxysilane) were weighed and dissolved in 300 cc of a toluene solvent.

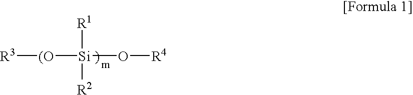

(wherein R¹, R², R³ and R⁴ respectively are a methyl group, and m is a mean degree of polymerization of 100)

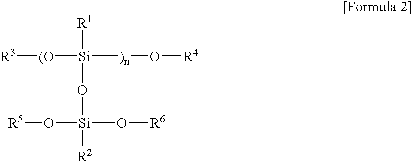

(wherein R¹, R², R³, R⁴, R⁵ and R⁶ respectively are a methyl group, and n is a mean degree of polymerization of 80)

Using a dip and dry coater, 10 kg of the ferrite particles were coated by stirring the resin coating solution for 20 minutes, and then were baked at 260° C. for 1 hour, thereby producing a carrier CA1.

(2) Production of Resin Dispersions

Next, examples of the toner of the present invention shall be described. The present invention, however, is not limited in any way to these examples.

Table 1 shows the characteristics of the binder resins obtained in resin particle dispersions (RL1, RL2, RL3, RH1, RH2, r14, r15, rh3, rh4) of the present invention that were prepared as preparation examples of resin particle dispersions. In Table 1, “Mn” is a number-average molecular weight, “Mw” is a weight-average molecular weight, “Mz” is a Z-average molecular weight, “Mw/Mn” is a ratio of weight-average molecular weight (Mw) and number-average molecular weight (Mn), “Mz/Mn” is a ratio of Z-average molecular weight (Mz) and number-average molecular weight (Mn), “Mp” is a peak value of a molecular weight, Tg (° C.) is a glass transition point, and Ts (° C.) is a softening point. Table 2 shows the amount (g) of nonion and the amount (g) of anion in a surfactant used in each resin particle dispersion and the proportion (wt. %) of the amount of nonion based on the total amount of surfactant.

TABLE 1

| | | | | | | | Thermal | |
|---|---|---|---|---|---|---|---|---|
| | | | | | | | characteristics | |
| | | | | | | | Glass | |
| Resin | Molecular weight characteristics | | | | | | transition | Softening |
| particle | Mn | Mw | Mz | Wm = | Wz = | Mp | point | point |
| dispersion | (×10⁴) | (×10⁴) | (×10⁴) | Mw/Mn | Mz/Mn | (×10⁴) | Tg(° C.) | Ts(° C.) |
| RL1 | 0.72 | 1.38 | 2.05 | 1.92 | 2.85 | 1.08 | 52 | 98 |
| RL2 | 0.75 | 1.76 | 3.01 | 2.35 | 4.01 | 1.85 | 47 | 106 |
| RL3 | 1.53 | 5.14 | 8.74 | 3.36 | 5.71 | 3.14 | 54 | 126 |
| rl4 | 0.41 | 0.76 | 4.30 | 1.85 | 10.49 | 0.70 | 39 | 89 |
| rl5 | 0.89 | 6.12 | 10.84 | 6.88 | 12.18 | 5.28 | 57 | 142 |
| RH1 | 1.43 | 5.14 | 18.90 | 3.59 | 13.22 | 5.80 | 58 | 144 |
| RH2 | 2.34 | 20.85 | 49.32 | 8.91 | 21.08 | 16.36 | 68 | 170 |
| rh3 | 0.26 | 2.83 | 9.62 | 10.88 | 37.00 | 0.27 | 43 | 135 |
| rh4 | 1.86 | 23.87 | 52.90 | 12.83 | 28.44 | 16.36 | 67 | 182 |

TABLE 2

| | | | | Proportion |
|---|---|---|---|---|
| | | | | of the |
| Resin | Nonipol 400 | Amount of | Amount of | amount of |
| particle | (Amount of | Neogen S20-F | anion | nonion |
| dispersion | nonion(g)) | (g) | (g) | (wt. %) |
| RL1 | 7.2 | 24 | 4.8 | 60.0 |
| RL2 | 7.5 | 22.5 | 4.5 | 62.5 |
| RL3 | 10 | 10 | 2 | 83.3 |
| rl4 | 5.8 | 31 | 6.2 | 48.3 |
| rl5 | 4.5 | 37.5 | 7.5 | 37.5 |
| RH1 | 6.5 | 27.5 | 5.5 | 54.2 |
| RH2 | 10.2 | 9 | 1.8 | 85.0 |
| rh3 | 5.5 | 32.5 | 6.5 | 45.8 |
| rh4 | 4.5 | 37.5 | 7.5 | 37.5 |

(a) Production of Resin Particle Dispersion RL1

A monomer solution containing 240.1 g of styrene, 59.9 g of n-butylacrylate and 4.5 g of acrylic acid was dispersed in 440 g of ion exchange water using 7.2 g of a nonionic surfactant (Nonipol 400, manufactured by Sanyo Chemical Industries, Ltd.), 24 g of an anionic surfactant (actual anion content: 4.8 g) (Neogen S20-F (20 wt. % concentration), manufactured by Dai-Ichi Kogyo Seiyaku Co., Ltd.) and 6 g of dodecanthiol. Then, 4.5 g of potassium persulfate was added, and emulsion polymerization was carried out at 75° C. for 4 hours, followed by an aging treatment at 90° C. for 2 hours. Thus, resin particle dispersion RL1 was prepared in which resin particles having Mn of 7200, Mw of 13800, Mz of 20500, Mp of 10800, Ts of 98° C., Tg of 52° C. and a median diameter of 0.14 μm were dispersed. The pH of the resin dispersion at this time was 1.8.

Table 3 shows the amount and other information for the monomers and the like used in each resin particle dispersion in the emulsion polymerization of each resin particle dispersion RL2, RL3, RH1, RH2, r14, r15, rh3 and rh4 based on the preparation of the resin particle dispersion RL1.

TABLE 3

| | | | | | | Carbon | | Emulsion | | Aging | | | |
|---|---|---|---|---|---|---|---|---|---|---|---|---|---|
| Resin | | n-butyl- | Acrylic | Ion | Dodecane- | tetra- | Potassium | polymerization | | treatment | | Median | pH of |
| particle | Styrene | acrylate | acid | exchange | thiol | bromide | persulfate | Temp. | time | Temp. | Time | diameter | resin |
| dispersion | (g) | (g) | (g) | water (g) | (g) | (g) | (g) | (° C.) | (h) | (° C.) | (h) | (μm) | dispersion |
| RL1 | 240.1 | 59.9 | 4.5 | 440 | 6 | 0 | 4.5 | 75 | 4 | 90 | 2 | 0.14 | 1.8 |
| RL2 | 230.1 | 69.9 | 4.5 | 440 | 6 | 0 | 4.5 | 75 | 4 | 90 | 5 | 0.18 | 1.9 |
| RL3 | 230.1 | 69.9 | 4.5 | 440 | 1.5 | 0 | 4.5 | 75 | 4 | 90 | 4 | 0.18 | 1.8 |
| rl4 | 240 | 60 | 4.5 | 440 | 1.5 | 3 | 3 | 75 | 5 | 80 | 2 | 0.18 | 1.7 |
| rl5 | 230.1 | 69.9 | 4.5 | 440 | 1.5 | 0 | 1.5 | 75 | 5 | 80 | 2 | 0.16 | 1.8 |
| RH1 | 230.1 | 69.9 | 4.5 | 440 | 1.5 | 0 | 1.5 | 75 | 4 | 90 | 4 | 0.14 | 2 |
| RH2 | 235 | 65 | 4.5 | 440 | 0 | 0 | 3 | 80 | 4 | 90 | 2 | 0.18 | 1.8 |
| rh3 | 255 | 45 | 4.5 | 440 | 1.5 | 3 | 3 | 75 | 5 | 80 | 2 | 0.18 | 2 |
| rh4 | 255 | 45 | 4.5 | 440 | 0 | 0 | 3 | 80 | 5 | 90 | 2 | 0.16 | 2.1 |

(3) Production of Pigment Dispersions

Table 4 and Table 5 show the black pigments used and the surfactants used.

TABLE 4

| | | | Particle | BET specific |
|---|---|---|---|---|
| Pigment | | DBP | size | surface area |
| particle | Carbon black | (ml/100 g) | (nm) | (m²/g) |
| CB1 | #45L (Mitsubishi Chemical | 45 | 24 | 125 |
| | Corporation) | | | |
| CB2 | REGAL250R (CABOT) | 46 | 35 | 50 |
| CB3 | #45 (Mitsubishi Chemical | 53 | 24 | 120 |
| | Corporation) | | | |
| CB4 | #52 (Mitsubishi Chemical | 63 | 27 | 88 |
| | Corporation) | | | |
| cb5 | #260 (Mitsubishi Chemical | 74 | 47 | 55 |
| | Corporation) | | | |
| cb6 | #44L (Mitsubishi Chemical | 78 | 24 | 110 |
| | Corporation) | | | |

TABLE 5

| | | | | Average |
|---|---|---|---|---|
| | | | | number |
| | | | | of moles |
| | | | Weight | ethylene |
| Dispersing | | | ratio | oxide |
| agent | Surfactant A | Surfactant B | (A:B) | added |
| AN1 | Eleminol NA200 | None | 100:0 | |
| AN2 | Eleminol NA200 | Neogen S20-F | 83:17 | |
| AN3 | Eleminol NA200 | Neogen S20-F | 67:33 | |
| AN4 | Eleminol NA200 | Neogen S20-F | 46:54 | |
| SA1 | Eleminol NA120 | None | 100:0 | 12 |
| SA2 | Eleminol NA400 | Eleminol NA120 | 21:79 | 18 |
| SA3 | Eleminol NA200 | None | 100:0 | 20 |
| SA4 | Eleminol NA400 | Eleminol NA120 | 50:50 | 26 |
| SA5 | Eleminol NA400 | Eleminol NA120 | 64:36 | 30 |
| SA6 | Eleminol NA400 | Eleminol NA120 | 75:25 | 33 |
| SA7 | Eleminol NA400 | None | 100:0 | 40 |

(a) Ion exchange water (308 g) and surfactant SA4 (12 g) were weighed and introduced into a 1 L beaker, and stirred with a magnetic stirrer until the solid portion of the surfactant dissolved. To this aqueous surfactant solution was added 80 g of carbon black CB1, and stirred for 10 minutes with the magnetic stirrer. Next, the contents were retransferred to a 1 L tall beaker and dispersed using a homogenizer (T-25, manufactured by IKA, Co., Ltd.) at 9500 rpm for 10 minutes. This dispersion further was dispersed using a dispersing device (T-K Filmix: 56-50, manufactured by Tokushu Kika Kogyo Co., Ltd.). The dispersion thus prepared was referred to as pigment particle dispersion CBS-1. The pigment concentration thereof was 20 wt. %.

Below, the details of the black pigments, surfactants and black pigment dispersions used in each black pigment dispersion are given that were prepared under the same conditions as in the preparation of the pigment particle dispersion CBS-1.

TABLE 6

| Carbon black particle | Carbon black | |
|---|---|---|
| dispersion | particles | Dispersing agent |
| CBS-1 | CB1 | SA4 |
| CBS-2 | CB2 | SA4 |
| CBS-3 | CB3 | SA4 |
| CBS-4 | CB4 | SA4 |
| cbs-5 | cb5 | SA4 |
| cbs-6 | cb6 | SA4 |
| CBS-7 | CB1 | AN1 |
| CBS-8 | CB1 | AN2 |
| CBS-9 | CB3 | AN3 |
| CBS-10 | CB4 | AN4 |
| CBS-11(12) | CB4 | SA1 |
| CBS-12(18) | CB3 | SA2 |
| CBS-13(20) | CB1 | SA3 |
| CBS-1(26) | CB1 | SA4 |
| CBS-14(30) | CB2 | SA5 |
| CBS-15(33) | CB3 | SA6 |
| CBS-16(40) | CB4 | SA7 |

To the fluids in which an anionic surfactant (Neogen S20-F (20 wt. % concentration), manufactured by Dai-Ichi Kogyo Seiyaku Co., Ltd.) was added ion exchange water so as to attain a pigment concentration of about 20 wt. %. The weight ratio in the table shows the actual quantitative ratio of anion.

(3) Production of Wax Dispersions

Table 7, Table 8 and Table 9 all show the wax materials and characteristics thereof used in the preparation of wax particle dispersions of this example that were prepared as preparation examples of wax particle dispersions.

TABLE 7

| | | Melting point | Heating loss | Iodine | Saponification |
|---|---|---|---|---|---|
| Wax | Ingredient | Tmw1(° C.) | Ck(wt %) | value | value |
| W1 | Highly hydrogenated jojoba oil | 68 | 2.8 | 2 | 95.7 |
| W2 | Highly hydrogenated meadowfoam oil | 71 | 2.5 | 2 | 90 |
| W3 | Carnauba wax | 84 | 1.5 | 8 | 88 |
| W4 | Jojoba oil fatty acid | 84 | 3.4 | 2 | 120 |
| | pentaerythritol monoester | | | | |

TABLE 8

| | | Melting point | Heating loss |
|---|---|---|---|
| Wax | Ingredient | Tmw1(° C.) | Ck(wt %) |
| W5 | Stearyl stearate | 58 | 2 |
| W6 | Stearic acid triglyceride | 63 | 1.5 |
| W7 | Behenyl behenate | 74 | 1.2 |
| W8 | Glycerol triester | 85 | 1.9 |
| | (hydrogenated castor oil) | | |

TABLE 9

| | | Melting point |
|---|---|---|
| Wax | Ingredient | Tmw2(° C.) |
| W11 | Saturated hydrocarbon wax (FNP0085, | 85 |
| | manufactured by Nippon Seiro Co., Ltd.) | |
| W12 | Saturated hydrocarbon wax (FNP0090, | 90 |
| | manufactured by Nippon Seiro Co., Ltd.) | |
| W13 | Polyolefin wax (PE890, manufactured by | 94 |
| | Clariant) | |
| W14 | Saturated hydrocarbon wax (LUVAX1151, | 98.2 |
| | manufactured by Nippon Seiro Co., Ltd.) | |

(a) Production of Wax Particle Dispersion WA1

FIG. 3 is a schematic view of a stirring/dispersing device (T-K Filmix, manufactured by Tbkushu Kika Kogyo Co., Ltd.), and FIG. 4 is a plan view thereof. Cooling water is introduced from 808 into the inside of an outer tank 801 and discharged through 807. Reference numeral 802 is a shielding board that stops the flow of the liquid to be treated. The shielding board 802 has an opening in the central portion, and the treated fluid is drawn from the opening and removed from the device through 805. Reference numeral 803 is a rotating body that is secured to a shaft 806 and rotates at high speed. There are holes having a size of about 1 to 5 mm in the side of the rotating body, and the liquid to be treated can move through the holes. The liquid to be treated is introduced into the tank in an amount of about one-half the capacity (120 ml) of the tank. The maximum rotational speed of the rotating body can be 50 m/s. The rotating body has a diameter of 52 mm, and the tank has an internal diameter of 56 mm. Reference numeral 804 is a material inlet used for a continuous treatment. In the case of a high-pressure treatment or batch treatment, the material inlet is closed.

The tank was kept at atmospheric pressure, and 67 g of ion exchange water, 3 g of a nonionic surfactant (Elminol NA400, manufactured by Sanyo Chemical Industries, Ltd.) and 30 g of wax (W-1) were blended and treated while the rotating body rotated at a speed of 30 m/s for 5 minutes and then 50 m/s for 2 minutes, thereby forming wax particle dispersion WA1.

Below, the types and characteristics of the waxes and the surfactants used in each wax particle dispersion (WA1 to WA4, wa5 to wa6, WA7 to WA12) are shown that were prepared under the same conditions as in the preparation of the wax particle dispersion WA1. The terms “first wax” and “second wax” refer to wax materials used in the wax particle dispersions, and the values in the parentheses after the characters indicating the type of waxes show the weight-based composition amount of the waxes (weight ratio).

TABLE 10

| | | | Surface-active agent | | | |
|---|---|---|---|---|---|---|
| | Wax | | | | Weight | |
| Wax particle | composition | | Surfactant | Surfactant | ratio | EO |
| dispersion | Wax | | A | B | (A:B) | number |
| WA1 | W-1 | | Eleminol | None | 100:0 | 40 |
| | | | NA400 | | | |
| WA2 | W-5 | | Eleminol | Neogen | 90:10 | |
| | | | NA400 | S20-F | | |
| WA3 | W-8 | | Eleminol | None | 100:0 | 40 |
| | | | NA400 | | | |
| WA4 | W-12 | | Eleminol | Neogen | 67:33 | |
| | | | NA400 | S20-F | | |
| wa5 | W-13 | | Eleminol | None | 100:0 | 40 |
| | | | NA400 | | | |
| wa6 | W-14 | | Eleminol | None | 100:0 | 40 |
| | | | NA400 | | | |
| | First | Second | | | | |
| | wax | wax | | | | |
| WA7 | W-1(1) | W-11(5) | Eleminol | None | 100:0 | 40 |
| | | | NA400 | | | |
| WA8 | W-2(1) | W-13(2) | Eleminol | Eleminol | 64:36 | 30 |
| | | | NA400 | NA120 | | |
| WA9 | W-3(1) | W-13(1) | Eleminol | Eleminol | 75:25 | 33 |
| | | | NA400 | NA120 | | |
| WA10 | W-5(1) | W-12(5) | Eleminol | None | 100:0 | 40 |
| | | | NA400 | | | |
| WA11 | W-7(1) | W-13(2) | Eleminol | None | 100:0 | 40 |
| | | | NA400 | | | |
| WA12 | W-8(1) | W-14(1) | Eleminol | Eleminol | 64:36 | 30 |
| | | | NA400 | NA120 | | |

When the anionic surface-active agent (NEOGEN S20-F (20 wt % concentration) manufactured by Dai-Ichi Kogyo Seiyaku Co., Ltd.) was used, the amount of the ion-exchanged water was adjusted so that the pigment concentration was set to about 20 wt %. The weight ratio in the table shows the actual quantitative ratio of anion, and the total quantity is the same. Moreover, when waxes W13, W14 and W15 were used, the inner pressure of the tank was increased to 0.4 MPa.

(5) Production of Toner Bases

(a) Production of Toner Base M1

Into a 2 litter glass container equipped with a thermometer, a cooling tube, a pH meter and a stirring blade were introduced 204 g of the first resin particle dispersion RL1, 56 g of the carbon black particle dispersion CBS-1, 60 g of the wax particle dispersion WA1 and 480 ml of ion exchange water and then mixed for 10 min using a homogenizer (Ultratalax T25, manufactured by IKA Co., Ltd.), thereby preparing a mixed particle dispersion.

The pH was controlled to 11.5 by adding 1N NaOH to the mixed dispersion thus obtained, and the dispersion was stirred for 10 min. Then, when the temperature reached 80° C. by increasing it from 20° C. at a rate of 1° C./min (the pH of the mixed particle dispersion was 10.1.), 300 g of an aqueous magnesium sulfate solution (23 wt. % concentration) whose pH had been controlled to 9.0 was continuously added in a dropwise manner over 30 min, and the dispersion was subjected to a heat treatment for 1 hour. The temperature then was increased to 90° C. for another heat treatment for 3 hours, thereby giving core particles. The pH of the obtained core particle dispersion was 8.2.

Thereafter, while the temperature of the fluid was 92° C., 145 g of the second resin particle dispersion RH1 whose pH had been controlled to 8.5 was added, and after the termination of the dropwise addition thereof, a heat treatment was carried out for 1.5 hours, thereby obtaining particles with which the second resin particles were fused.

After cooling, the reaction product (toner base) was filtered and washed three times with ion exchange water. The toner base thus obtained was dried at 40° C. for 6 hours using a fluid-type dryer, resulting in a toner base having a volume-average particle size of 3.7 μm and a coefficient of variation of 15.9.

(b) Production of Toner Base M3

Into a 2 litter glass container equipped with a thermometer, a cooling tube, a pH meter and a stirring blade were introduced 204 g of the first resin particle dispersion RL1, 56 g of the carbon black particle dispersion CBS-3, 60 g of the wax particle dispersion WA3 and 480 ml of ion exchange water and then mixed for 10 min using a homogenizer (Ultratalax T25, manufactured by IKA Co., Ltd.), thereby preparing a mixed particle dispersion.

The pH was controlled to 9.7 by adding 1N NaOH to the mixed dispersion thus obtained, and the dispersion was stirred for 10 min. Then, when the temperature reached 80° C. by increasing it from 20° C. at a rate of 1° C./min (the pH of the mixed particle dispersion was 8.4.), 300 g of an aqueous magnesium sulfate solution (23 wt. % concentration) whose pH had been controlled to 5.4 was continuously added in a dropwise manner over 100 min, and the dispersion was heated for 1 hour. The temperature was increased to 90° C. for a heat treatment for 3 hours, thereby giving core particles. The pH of the resulting core particle dispersion was 7.0.

Thereafter, while the temperature of the fluid was 92° C., 145 g of the second resin particle dispersion liquid RH1 whose pH had been controlled to 6.8 was added, and after the termination of the dropwise addition thereof, a heat treatment was carried out for 1.5 hours, thereby obtaining particles with which the second resin particles were fused.

After cooling, the reaction product (toner base) was filtered and washed three times with ion exchange water. The toner base thus obtained was dried at 40° C. for 6 hours using a fluid-type dryer, resulting in a toner base having a volume-average particle size of 6.7 m and a coefficient of variation of 17.5.

Toner bases M2, M4 and M5 were prepared under the same conditions as in the preparation of M1 except that carbon black particle dispersions and wax particle dispersions were different, and the aggregability of the core particles was observed.

(c) Production of Toner Base M6

Into a 2 litter glass container equipped with a thermometer, a cooling tube, a pH meter and a stirring blade were introduced 204 g of the first resin particle dispersion RL1, 56 g of the carbon black particle dispersion CBS-2, 60 g of the wax particle dispersion WA8 and 480 ml of ion exchange water and then mixed for 10 min using a homogenizer (Ultratalax T25, manufactured by IKA Co., Ltd.), thereby preparing a mixed particle dispersion.

Thereafter, the pH was controlled to 11.5 by adding 1N NaOH to the mixed dispersion thus obtained, 300 g of an aqueous magnesium sulfate solution (23 wt. % concentration) was then added, and the dispersion was stirred for 10 min. The temperature was increased to 90° C. from 20° C. at a rate of 1° C./min, and a heat treatment was carried out for 3 hours, thereby giving core particles. The pH of the resulting core particle dispersion was 9.1.

Thereafter, while the temperature of the fluid was 92° C., 145 g of the second resin particle dispersion liquid RH1 whose pH had been controlled to 6.8 was added, and after the termination of the dropwise addition thereof, a heat treatment was carried out for 1.5 hours, thereby obtaining particles with which the second resin particles were fused.

After cooling, the reaction product (toner base) was filtered and washed three times with ion exchange water. The toner base thus obtained was dried at 40° C. for 6 hours using a fluid-type dryer, resulting in a toner base having a volume-average particle size of 4.7 m and a coefficient of variation of 17.4.

Toner bases M7 to M10, m11 to m15 and M16 were prepared and evaluated under the same conditions as with M6 except that carbon black particle dispersions and wax particle dispersions were different. Toner bases M18 to M20 and M24 to M26 were prepared and evaluated under the same conditions as with M6 except that carbon black particle dispersions and wax particle dispersions were different, and the aggregability of the core particles was observed.

Toner bases M17 and M21 to M23 were prepared and evaluated under the same conditions as with M1 except that carbon black particle dispersions and wax particle dispersions were different.

Table 11 shows the composition of each toner base with respect to the toner bases (M1 to M10 and M16 to M26) of the present invention that were prepared as examples of preparing toner bases and the toner bases (m11 to m15) for comparison, and shows the characteristics of the toner bases thus prepared. Table 12 shows the aggregability of the core particles, d50 (μm) refers to the volume-average particle size of the toner base particles, and the term “coefficient of variation” reveals the characteristics showing the expansion of the particle size distribution of the toner base particles in a toner base on a volumetric basis.

TABLE 11

| | Composition | | | | | | | | | |
|---|---|---|---|---|---|---|---|---|---|---|
| | First | | | | | | Second | | Amount of | |
| Toner | resin | Amount | Black | Amount | Wax | Amount | resin | Amount | MgSO₄ | Ion |
| base | particle | added | pigment | added | particle | added | particle | added | solution | exchange |
| particles | dispersion | (g) | particle | (g) | dispersion | (g) | dispersion | (g) | (g) | water |
| M1 | RL1 | 204 | CBS-1 | 56 | WA1 | 60 | RH1 | 145 | 300 | 480 |
| M2 | RL1 | 204 | CBS-2 | 56 | WA2 | 60 | RH1 | 145 | 300 | 480 |
| M3 | RL1 | 204 | CBS-3 | 56 | WA3 | 60 | RH1 | 145 | 300 | 480 |
| M4 | RL2 | 204 | CBS-4 | 44 | WA4 | 30 | RH2 | 70 | 240 | 350 |
| M5 | RL2 | 204 | CBS-1 | 44 | WA7 | 30 | RH2 | 70 | 240 | 350 |
| M6 | RL1 | 204 | CBS-2 | 56 | WA8 | 60 | RH1 | 145 | 300 | 480 |
| M7 | RL1 | 204 | CBS-3 | 56 | WA9 | 60 | RH1 | 145 | 300 | 480 |
| M8 | RL1 | 204 | CBS-4 | 56 | WA10 | 60 | RH1 | 145 | 300 | 480 |
| M9 | RL2 | 204 | CBS-1 | 44 | WA11 | 30 | RH2 | 70 | 240 | 350 |
| M10 | RL2 | 204 | CBS-2 | 44 | WA12 | 30 | RH2 | 70 | 240 | 350 |
| m11 | RL1 | 204 | cbs-5 | 44 | WA12 | 60 | RH2 | 70 | 240 | 350 |
| m12 | RL1 | 204 | cbs-6 | 44 | WA12 | 60 | RH2 | 70 | 240 | 350 |
| m13 | RL1 | 204 | CBS-4 | 44 | wa5 | 60 | RH2 | 70 | 240 | 350 |
| m14 | RL2 | 204 | CBS-4 | 44 | wa6 | 60 | RH2 | 70 | 240 | 350 |
| m15 | RL2 | 204 | cbs-5 | 44 | wa5 | 60 | RH2 | 70 | 240 | 350 |
| M16 | RL1 | 204 | CBS-9 | 56 | WA2 | 60 | RH1 | 145 | 300 | 480 |
| M17 | RL2 | 204 | CBS-8 | 56 | WA3 | 60 | RH2 | 70 | 240 | 350 |
| M18 | RL2 | 204 | CBS-8 | 44 | WA4 | 30 | RH1 | 145 | 300 | 480 |
| M19 | RL3 | 204 | CBS-9 | 44 | WA4 | 30 | RH2 | 70 | 240 | 350 |
| M20 | RL1 | 204 | CBS-12 | 56 | WA1 | 60 | RH1 | 145 | 300 | 480 |
| M21 | RL1 | 204 | CBS-13 | 44 | WA3 | 30 | RH2 | 70 | 240 | 350 |
| M22 | RL2 | 204 | CBS-1 | 56 | WA10 | 60 | RH1 | 145 | 300 | 480 |
| M23 | RL2 | 204 | CBS-14 | 44 | WA7 | 30 | RH2 | 70 | 240 | 350 |
| M24 | RL3 | 204 | CBS-15 | 56 | WA11 | 60 | RH1 | 145 | 300 | 480 |
| M25 | RL3 | 204 | CBS-11 | 44 | WA12 | 30 | RH1 | 145 | 300 | 480 |
| M26 | RL3 | 204 | CBS-16 | 56 | WA12 | 60 | RH2 | 70 | 240 | 350 |

TABLE 12

| | | Toner base particles | |
|---|---|---|---|
| | | | Volume-based |
| Toner base | Aggregability of core | | coefficient of |
| dispersion | particles | d50 (μm) | variation |
| M1 | Transparent in 2 h | 3.7 | 15.9 |
| M2 | Transparent in 2 h | 3.8 | 16.1 |
| M3 | Transparent in 3 h | 6.7 | 17.5 |
| M4 | Transparent in 3 h | 4.2 | 18.1 |
| M5 | Transparent in 2 h | 3.9 | 15.4 |
| M6 | Transparent in 3 h | 4.7 | 17.4 |
| M7 | Transparent in 3 h | 4.9 | 18.1 |
| M8 | Transparent in 3 h | 4.9 | 18.4 |
| M9 | Transparent in 3 h | 4.1 | 18.4 |
| M10 | Transparent in 3 h | 5.1 | 17.9 |
| m11 | Black turbid | 9.9 | 32.1 |
| m12 | Black turbid | 8.2 | 33.4 |
| m13 | Gray black turbid | 10.8 | 29.8 |
| m14 | Gray black turbid | 8.7 | 28.9 |
| m15 | Black turbid | 9.7 | 36.4 |
| M16 | Transparent in 3 h | 4.2 | 18.4 |
| M17 | Transparent in 2 h | 3.8 | 15.9 |
| M18 | Substantially | 6.9 | 25.8 |
| | transparent in 6 h | | |
| M19 | Substantially | 6.5 | 26.8 |
| | transparent in 6 h | | |
| M20 | Transparent in 3 h | 4.1 | 15.9 |
| M21 | Transparent in 2 h | 3.8 | 16.2 |
| M22 | Transparent in 2 h | 4.1 | 16.8 |
| M23 | Transparent in 2 h | 4 | 16.2 |
| M24 | Transparent in 3 h | 5.8 | 18.9 |
| M25 | Substantially | 7.1 | 24.8 |
| | transparent in 6 h | | |
| M26 | Substantially | 7.6 | 25.9 |
| | transparent in 6 h | | |

In the process of producing a toner by the aggregation and fusion of fine pigment particles and fine particles of wax with fine emulsified resin particles, the verification of whether the fine pigment particles and the fine particles of wax are incorporated into the fine resin particles by being enclosed therewith can be carried out by removing part of the reaction mixture during the aggregation and fusion reaction at a specific time interval and subjecting the reaction mixture to centrifugal separation. When the fine pigment particles and the fine particles of wax are incorporated into the toner, the reaction mixture is separated into a solid layer and a liquid layer, i.e., 2 layers, once subjected to centrifugal separation, and the supernatant liquid is clear and colorless. When the fine pigment particles and the fine particles of wax are not incorporated into the toner, the supernatant liquid appears white turbid. Moreover, when the fine pigment particles and the fine particles of wax are not incorporated into the toner, the supernatant liquid has the hue of the pigment. For example, the supernatant liquid appears cyan when cyan toner is used, or appears black when black toner is used.

The aggregability of core particles means a condition obtained when a dispersion sampled during the core particle aggregation reaction is diluted with the same amount of ion exchange water, introduced into a test tube and centrifuged by a centrifuge at 3000 min⁻¹ for 5 min, and the turbidity of the supernatant after centrifugation is visually inspected.

The supernatant liquids of M1 to M10, M16, M17, and M20 to M24 became transparent in 2 hours (h) to 3 hours (h), showing that particles that have a small particle size and a sharp particle size distribution were obtained.

With respect to m11-m15, poorly aggregated, suspended carbon black particles or particles of wax that did not aggregated with the resin particles. When a supernatant liquid was turbid due to the color of the black pigment, it was referred to as being black turbid. The term gray black turbid refers to a state in which a supernatant liquid remained gray black turbid due to the presence of suspended particles of the carbon black and the wax. In this case, the second resin particles were forcibly subjected to adhesion while the supernatant is in the state of being black turbid or the like.

Although the supernatants of M18, M19, M25 and M26 became substantially transparent in 6 hours, the particle size distributions were rather broad and likely expanded. In the image evaluation, fogging and the phenomenon of some characters not being transferred were observed slightly more than with other toners, but these toners were still at the practically usable level.

Thus, by using a carbon black having a specific DBP oil absorption and a wax having a specific melting point, the presence of suspended particles that are not involved in the aggregation of the carbon black particles and the particles of wax due to an aggregation failure can be eliminated, and particles that have a small particle size and a sharp particle size distribution can be obtained.

Moreover, in the emulsified fine resin particles, fine carbon black particles and fine particles of wax dispersed with mixed surfactants composed of a nonionic surfactant and an anionic surfactant, by specifying the weight-based mixing ratio of the nonionic surfactant and the anionic surfactant in each type of particles, the presence of suspended particles that are not involved in the aggregation of the carbon black particles and the particles of wax due to an aggregation failure can be eliminated, and particles that have a small particle size and a sharp particle size distribution can be obtained.

Furthermore, when the emulsified fine resin particles dispersed with a mixed surfactant composed of a nonionic surfactant and an anionic surfactant, the fine carbon black particles dispersed with a nonionic surfactant and the particles of wax dispersed with a nonionic surfactant are aggregated, by specifying that the average number of moles of ethylene oxide added to the nonionic surfactant for use in dispersing the wax is larger than the average number of moles of ethylene oxide added to the nonionic surfactant for use in dispersing the carbon black dispersion, the presence of suspended particles that are not involved in the aggregation of the carbon black particles and the particles of wax due to an aggregation failure can be eliminated, and particles that have a small particle size and a sharp particle size distribution can be obtained.

(6) Additives

Next, examples of additives shall be described. Table 13 shows the ingredients and characteristics of the additives (S1, S2, S3, S4, S5, S6, S7, S8, S9) used in this example.

Those that are treated with a plurality of additives, i.e., treatment ingredient 1 and treatment ingredient 2, are provided with a weight-based mixing ratio in the parentheses. The terms “5-minute value” and “30-minute value” indicate charge amounts (μC/g) and were measured by a blow-off method using frictional charge with an uncoated ferrite carrier. Specifically, under the environmental conditions of 25° C. and 45% RH, 50 g of a carrier and 0.1 g of silica or the like were mixed in a 100 ml polyethylene container, and then stirred by vertical rotation at a speed of 100 min⁻¹ for 5 minutes and 30 minutes, respectively. Thereafter, 0.3 g of a sample was removed for each stirring time, and nitrogen gas was blown on the samples at 1.96×10⁴ (Pa) for 1 minute.

TABLE 13

| | | | | Properties | | | | | Charge amount | | |
|---|---|---|---|---|---|---|---|---|---|---|---|
| | | | | | | Amount of | | | | | 5-Min. |
| Fine | | Treatment ingredient | | | | moisture | Ignition | Drying | 5-Min. | 30-Min. | value/ |
| inorganic | Technical | Treatment | Treatment | Particle | Methanol | absorption | loss | loss | value | value | 30-min. |
| particles | product | ingredient 1 | ingredient 2 | size (nm) | titration (%) | (wt %) | (wt %) | (wt %) | (μC/g) | (μC/g) | value |
| S1 | Silica | Dimethyl | None | 6 | 88 | 0.1 | 10.5 | 0.2 | −820 | −710 | 86.59 |
| | | polysiloxane-treated | | | | | | | | | |
| | | silica | | | | | | | | | |
| S2 | Silica | Methylhydrogen | None | 16 | 88 | 0.1 | 5.5 | 0.2 | −560 | −450 | 80.36 |
| | | polysiloxane-treated | | | | | | | | | |
| | | silica | | | | | | | | | |
| S3 | Silica | Methylhydrogen | None | 40 | 88 | 0.1 | 10.8 | 0.2 | −580 | −480 | 82.76 |
| | | polysiloxane (1) | | | | | | | | | |
| S4 | Silica | Dimethyl polysiloxane | Aluminum | 40 | 84 | 0.09 | 24.5 | 0.2 | −740 | −580 | 78.38 |
| | | (20) | distearate (2) | | | | | | | | |
| S5 | Silica | Methylhydrogen | Stearic acid | 40 | 88 | 0.1 | 10.8 | 0.2 | −580 | −480 | 82.76 |
| | | polysiloxane (1) | amide (1) | | | | | | | | |
| S6 | Silica | Dimethyl polysiloxane | Fatty acid | 80 | 88 | 0.12 | 15.8 | 0.2 | −620 | −475 | 76.61 |
| | | (2) | pentaerythritol | | | | | | | | |
| | | | monoester (1) | | | | | | | | |
| S7 | Silica | Methylhydrogen | None | 150 | 89 | 0.10 | 6.8 | 0.2 | −580 | −480 | 82.76 |
| | | polysiloxane (1) | | | | | | | | | |
| S8 | Titanium | Diphenyl polysiloxane | Na stearate (1) | 80 | 88 | 0.1 | 18.5 | 0.2 | −750 | −650 | 86.67 |
| | oxide | (10) | | | | | | | | | |
| S9 | Silica | Hexamethyldisilazane- | None | 16 | 68 | 0.60 | 1.6 | 0.2 | −800 | −620 | 77.50 |
| | | treated silica | | | | | | | | | |

It is preferable that the 5-minute value is −100 to −800 μC/g and the 30-minute value is −50 to −600 μC/g for the negative chargeability. Silica having a high charge amount can function well in a small quantity.

(7) Composition of Toner and Additive Treatment

Next, examples of the composition of toner and an additive treatment shall be described. Table 14 shows the composition of the toner ingredients of each toner of the present invention that was prepared as a preparation example of toner. The term “none” means that no additive was added. The value in the parentheses at the end of the characters indicating the additives in the additive columns is the amount (parts by weight) of the additive added per 100 parts by weight of toner base. The additive treatment was performed using a Henschel Mixer FM20B (manufactured by Mitsui Mining Co., Ltd.) with a ZOSO-type mixer blade, a revolution of 2000 min⁻¹, a treating time of 5 minutes, and an input amount of 1 kg.

TABLE 14

| | Composition | | | |
|---|---|---|---|---|
| | | Additive | | |
| Toner | Toner base | Additive A | Additive B | Additive C |
| TM1 | M1 | S1(0.6) | S3(2.5) | None |
| TM2 | M2 | S2(1.8) | S4(1.5) | None |
| TM3 | M3 | S1(1.8) | S5(1.2) | None |
| TM4 | M4 | S2(2.5) | None | None |
| TM5 | M5 | S1(2.0) | S6(2.0) | None |
| TM6 | M6 | S2(1.8) | S7(3.5) | None |
| TM7 | M7 | S1(0.6) | S8(2.0) | S7(1.5) |
| TM8 | M8 | S1(0.6) | S7(3.5) | S7(1.5) |
| TM9 | M9 | S2(0.8) | S4(1.5) | None |
| TM10 | M10 | S2(0.8) | S4(1.5) | None |
| tm11 | m11 | S2(0.8) | S4(1.5) | None |
| tm12 | m12 | S2(0.8) | S4(1.5) | None |
| tm13 | m13 | S2(0.8) | S4(1.5) | None |
| tm14 | m14 | S2(0.8) | S4(1.5) | None |
| tm15 | m15 | S2(0.8) | S4(1.5) | None |
| TM16 | M16 | S1(1.0) | S6(2.0) | None |
| TM17 | M17 | S1(1.0) | S7(3.0) | None |
| TM18 | M18 | S2(2.5) | None | None |
| TM19 | M19 | S1(2.0) | S6(2.0) | None |
| TM20 | M20 | S2(1.8) | S7(3.5) | None |
| TM21 | M21 | S1(0.6) | S8(2.0) | S7(1.5) |
| TM22 | M22 | S1(0.6) | S7(3.5) | S7(1.5) |
| TM23 | M23 | S1(0.6) | S8(2.0) | None |
| TM24 | M24 | S1(0.6) | S7(3.5) | None |
| TM25 | M25 | S2(1.8) | S4(1.5) | None |
| TM26 | M26 | S1(2.0) | S6(2.0) | None |

Permanent Rubine F6B manufactured by Clariant was used as another magenta toner, Ketblue 111 manufactured by Dainippon Ink and Chemicals, Inc was used as cyan toner, and PY74 manufactured by Sanyo Color Works, Ltd., was used as yellow toner, and they were combined so as to have the same composition as in the toner M1.

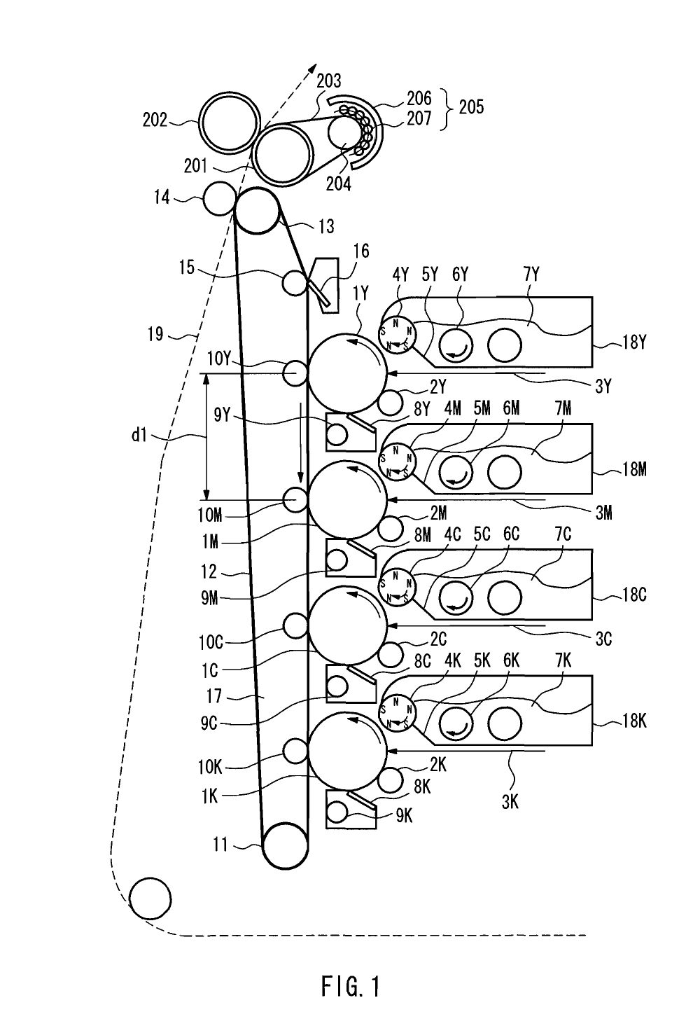

FIG. 1 is a cross-sectional view showing the configuration of a full-color image forming apparatus used in this example. In FIG. 1, the outer housing of a color electrophotographic printer is not shown. A transfer belt unit 17 includes a transfer belt 12, a first color (yellow) transfer roller 10Y, a second color (magenta) transfer roller 10M, a third color (cyan) transfer roller 10C, a fourth color (black) transfer roller 10K, a driving roller 11 made of aluminum, a second transfer roller 14 made of an elastic body, a second transfer follower roller 13, a belt cleaner blade 16 for cleaning a toner image that remains on the transfer belt 12, and a roller 15 located opposite the belt cleaner blade 16. The distance between the first color (Y) transfer position and the second color (M) transfer position is 70 mm (which is the same as the distance between the second color (M) transfer position and the third color (C) transfer position and the distance between the third color (C) transfer position and the fourth color (K) transfer position). The circumferential velocity of a photoconductive member is 125 mm/s.

The transfer belt 12 can be obtained by kneading a conductive filler in an insulating polycarbonate resin and making a film with an extruder. In this example, polycarbonate resin (e.g., Iupilon Z300 manufactured by Mitsubishi Gas Chemical Co., Inc.) was used as the insulating resin, and 5 parts by weight of conductive carbon (e.g., Ketjenblack) was added to 95 parts by weight of the polycarbonate resin to form a film. The surface of the film was coated with a fluorocarbon resin. The film had a thickness of about 100 μm, a volume resistance of 10⁷ to 10¹²Ω·cm, and a surface resistance of 10 10⁷ to 10¹²Ω/□ (quadrature). The use of this film can improve the dot reproducibility and prevent slackening of the transfer belt 12 that is caused by a long-term use and charge accumulation effectively. By coating the film surface with a fluorocarbon resin, the filming of toner on the surface of the transfer belt 12 due to a long-term use can be also suppressed effectively. When the volume resistance is less than 10⁷Ω·cm, retransfer is likely to occur. When the volume resistance is more than 10¹²Ω·cm, the transfer efficiency is impaired.

A first transfer roller 10 is a urethane foam roller of conductive carbon and has an outer diameter of 8 mm. The resistance value is 10² to 10⁶Ω. In the first transfer operation, the first transfer roller 10 is pressed against a photoconductive member 1 with a force of about 1.0 to 9.8 (N) via the transfer belt 12, so that the toner is transferred from the photoconductive member 1 to the transfer belt 12. When the resistance value is less than 10²Ω, retransfer is likely to occur. When the resistance value is more than 10⁶Ω, a transfer failure is likely to occur. The force less than 1.0 (N) may cause a transfer failure, and the force more than 9.8 (N) may cause transfer void.

The second transfer roller 14 is a urethane foam roller of conductive carbon and has an outer diameter of 10 mm. The resistance value is 10² to 10⁶Ω. The second transfer roller 14 is pressed against the second transfer follower roller 13 via the transfer belt 12 and a transfer medium 19 such as paper or an OHP sheet. The second transfer follower roller 13 is rotated in accordance with the movement of the transfer belt 12. In the second transfer operation, the second transfer roller 14 is pressed against the second transfer follower roller 13 with a force of 5.0 to 21.8 (N), so that the toner is transferred from the transfer belt to the transfer medium 19. When the resistance value is less than 10²Ω, retransfer is likely to occur. When the resistance value is more than 10⁶Ω, a transfer failure is likely to occur. The force less than 5.0 (N) may cause a transfer failure, and the force more than 21.8 (N) may increase the load and generate jitter easily.

Four image forming units 18Y, 18M, 18C and 18K for yellow (Y), magenta (M), cyan (C) and black (K) are arranged in series as shown in FIG. 1.

The image forming units 18Y, 18M, 18C and 18K have the same components except for a developer contained therein. For simplification, only the image forming unit 18Y for yellow (Y) shall be described, and a description of the other units shall be omitted.

The image forming unit is configured as follows. Reference numeral 1 refers to a photoconductive member, 3 refers to pixel laser signal light, and 4 refers to a developing roller composed of aluminum that has an outer diameter of 10 mm and includes a magnet with a magnetic force of 1200 gauss. The developing roller 4 is located opposite the photoconductive member with a gap of 0.3 mm between them, and rotates in the direction of the arrow. A stirring roller 6 stirs toner and a carrier in a developing unit and supplies the toner to the developing roller. The mixing ratio of the toner to the carrier is read from a permeability sensor (not shown), and the toner is supplied timely from a toner hopper (not shown). A magnetic blade 5 is made of metal and controls a magnetic brush layer of a developer on the developing roller. In this example, 150 g of developer was introduced, and the gap was 0.4 mm. Although a power supply is not shown in FIG. 1, a direct voltage of −500 V and an alternating voltage of 1.5 kV (p-p) at a frequency of 6 kHz were applied to the developing roller 4. The circumferential velocity ratio of the photoconductive member to the developing roller was 1:1.6. The mixing ratio of the toner to the carrier was 93:7. The amount of developer in the developing unit was 150 g.

A charging roller 2 is made of epichlorohydrin rubber and has an outer diameter of 10 mm. A direct-current bias of −1.2 kV is applied thereto for charging the surface of the photoconductive member 1 to −600 V. Reference numeral 8 refers to a cleaner, 9 refers to a waste toner box, and 7 refers to a developer.

Paper is conveyed from the lower side of the transfer belt unit 17, and a paper conveying path is formed so that paper 19 is transported by a paper feed roller (not shown) to a nip portion where the transfer belt 12 and the second transfer roller 14 are pressed against each other.

The toner is transferred from the transfer belt 12 to the paper 19 by +1000 V applied to the second transfer roller 14, and then is conveyed to a fixing portion in which the toner is fixed. The fixing portion includes a fixing roller 201, a pressure roller 202, a fixing belt 203, a heat roller 204, and an induction heater 205.

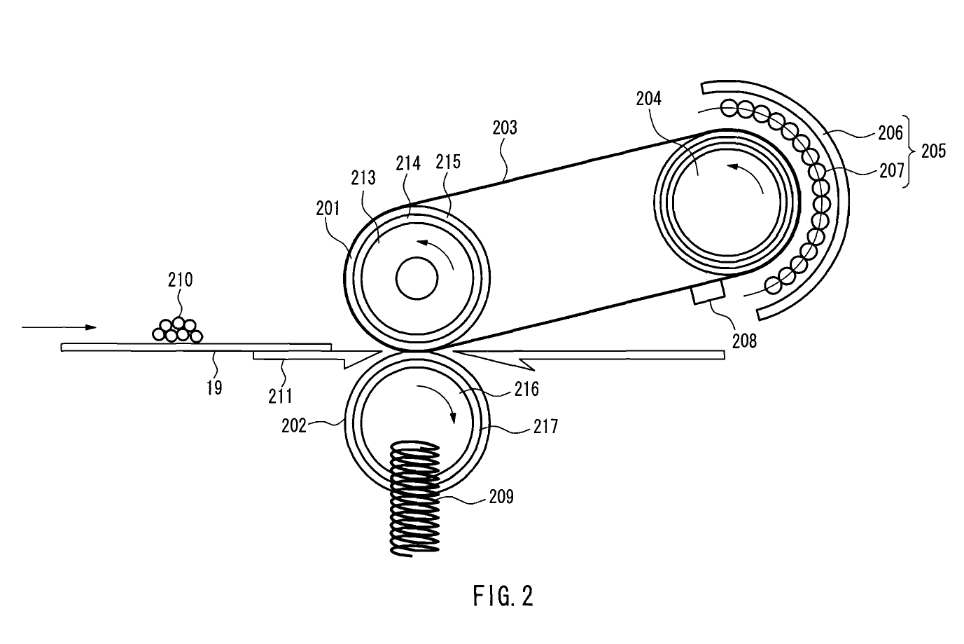

FIG. 2 shows a fixing process. A belt 203 runs between the fixing roller 201 and the heat roller 204. A predetermined load is applied between the fixing roller 201 and the pressure roller 202 so that a nip is formed between the belt 203 and the pressure roller 202. The induction heater 205 including a ferrite core 206 and a coil 207 is provided on the periphery of the heat roller 204, and a temperature sensor 208 is arranged on the outer surface.

The belt is formed by arranging a Ni substrate (30 μm), silicone rubber (150 μm) and a PFA tube (30 μm) in layers.

The pressure roller 202 is pressed against the fixing roller 201 by a pressure spring 209. A recording material 19 having the toner 210 is moved along a guide plate 211.

The fixing roller 201 (fixing member) includes a hollow core 213, an elastic layer 214 formed on the hollow core 213, and a silicone rubber layer 215 formed on the elastic layer 214. The hollow core 213 is made of aluminum and has a length of 250 mm, an outer diameter of 14 mm and a thickness of 1 mm. The elastic layer 214 is made of silicone rubber with a rubber hardness (JIS-A) of 20 degrees according to the JIS standard and has a thickness of 3 mm. The silicone rubber layer 215 has a thickness of 3 mm. Therefore, the outer diameter of the fixing roller 201 is about 26 mm. The fixing roller 201 is rotated at 125 mm/s by receiving a driving force from a driving motor (not shown).

The heat roller 204 includes a hollow pipe having a thickness of 1 mm and an outer diameter of 20 mm. The surface temperature of the fixing belt is controlled to 170° C. using a thermistor.

The pressure roller 202 (pressure member) has a length of 250 mm and an outer diameter of 20 mm, and includes a hollow core 216 and an elastic layer 217 formed on the hollow core 216. The hollow core 216 is made of aluminum and has an outer diameter of 16 mm and a thickness of 1 mm. The elastic layer 217 is made of silicone rubber with a rubber hardness (JIS-A) of 55 degrees according to the JIS standard and has a thickness of 2 mm. The pressure roller 202 is mounted rotatably, and a 5.0 mm width nip is formed between the pressure roller 202 and the fixing roller 201 under a one-sided load of 147N given by the spring 209.

The operations shall be described below. In the full color mode, all the first transfer rollers 10 of Y, M, C and K are lifted and pressed against the respective photoconductive members 1 of the image forming units via the transfer belt 12. At this time, a direct-current bias of +800 V is applied to each of the first transfer rollers. An image signal is transmitted through the laser beam 3 and enters the photoconductive member 1 whose surface has been charged by the charging roller 2, thus forming an electrostatic latent image. The electrostatic latent image formed on the photoconductive member 1 is made visible by the toner on the developing roller 4 that is rotated in contact with the photoconductive member 1.

In this case, the image formation rate (125 mm/s, which is equal to the circumferential velocity of the photoconductive member) of the image forming unit 18Y is set so that the speed of the photoconductive member is 0.5 to 1.5% slower than the traveling speed of the transfer belt 12.

In the image forming process, signal light 3Y is input to the image forming unit 18Y, and an image is formed with Y toner. At the same time as the image formation, the Y toner image is transferred from the photoconductive member 1Y to the transfer belt 12 by the action of the first transfer roller 10Y to which a direct voltage of +800 V is applied.

There is a time lag between the first transfer of the first color (Y) and the first transfer of the second color (M). Then, signal light 3M is input to the image forming unit 18M, and an image is formed with M toner. At the same time as the image formation, the M toner image is transferred from the photoconductive member 1M to the transfer belt 12 by the action of the first transfer roller 10M. In this case, the M toner is transferred onto the first color (Y) toner that has been formed. Subsequently, the C (cyan) toner and K (black) toner images are formed in the same manner and transferred by the action of the first transfer rollers 10C and 10K. Thus, YMCK toner images are formed on the transfer belt 12. This is a so-called tandem process.

A color image is formed on the transfer belt 12 by superimposing the four color toner images in registration. After the last transfer of the K toner image, the four color toner images are transferred collectively in a synchronized manner to the paper 19 fed by a feeding cassette (not shown) by the action of the second transfer roller 14. In this case, the second transfer follower roller 13 is grounded, and a direct voltage of +1 kV is applied to the second transfer roller 14. The toner images transferred to the paper are fixed by a pair of fixing rollers 201 and 202. Then, the paper is ejected through a pair of ejecting rollers (not shown) to the outside of the apparatus. The toner that is not transferred and remains on the transfer belt 12 is cleaned by the belt cleaner blade 16 to prepare for the next image formation.

### Examples of Evaluations of Image Creation

Next, examples of image creation using toners and two-component developers shall be described. Here, a long-term test by outputting 100000 sheets of A4-size paper was carried out using an image forming apparatus with respect to a plurality of two-component developers containing toners and carriers in various ratios, and the amount of charge and the image density were measured, and background fogging in non-image portions, uniformity of whole-page solid image, transferability (omission of characters, reverse transfer and transfer void during transfer), and filming of toner in an output sample were evaluated. For the image density (ID) evaluation, the black solid image portions were measured using a reflection density meter (RD-914, manufactured by the Macbeth Division of Kollmorgen Instruments Corporation).

The amount of charge was measured according to the blow-off method using frictional charge with a ferrite carrier. Specifically, under the environmental conditions of 25° C. and 45% RH, 0.3 g of a long-term test sample was collected, and a nitrogen gas was blown on the sample at 1.96×10⁴ Pa for 1 minute.

Table 15 shows the results of the evaluation in connection with the long-term test by outputting 100000 sheets of A4-size paper carried out with respect to each of the two-component developers (DM1 to DM10 and DM16 to DM26) of the present invention that are composed of toners and carriers as two-component developers. In the table, “A” means that the result of the evaluation was good, “B” means that the result of the evaluation was slightly unsatisfactory, and “C” means that the result of the evaluation was unsatisfactory.

With respect to the extent of fogging, when the value measured using a spectrolino spectro scan was 0.07 or less, “A” was given to mean good; when 0.07 to 0.1, “B” was given to mean slightly more fogging; and when 0.1 or more, “C” was given to mean unsatisfactory.

TABLE 15

| | | | Evaluation 1 | | | | | | | |
|---|---|---|---|---|---|---|---|---|---|---|
| | | | filming on | Image density | | | Uniformity of | Omission of | | |
| | Composition | | photosensitive | | After | | whole-page | characters | Reverse | Transfer |
| Developer | Toner | Carrier | member | Initial | test | Fogging | solid image | during transfer | transfer | void |
| DM1 | TM1 | CA1 | No | 1.45 | 1.44 | A | A | A | A | A |
| DM2 | TM2 | CA1 | No | 1.48 | 1.45 | A | A | A | A | A |
| DM3 | TM3 | CA1 | No | 1.50 | 1.52 | A | A | A | A | A |
| DM4 | TM4 | CA1 | No | 1.42 | 1.44 | A | A | A | A | A |
| DM5 | TM5 | CA1 | No | 1.46 | 1.42 | A | A | A | A | A |
| DM6 | TM6 | CA1 | No | 1.44 | 1.41 | A | A | A | A | A |
| DM7 | TM7 | CA1 | No | 1.42 | 1.41 | A | A | A | A | A |
| DM8 | TM8 | CA1 | No | 1.49 | 1.42 | A | A | A | A | A |
| DM9 | TM9 | CA1 | No | 1.45 | 1.42 | A | A | A | A | A |
| DM10 | TM10 | CA1 | No | 1.48 | 1.42 | A | A | A | A | A |
| dm11 | tm11 | CA1 | Yes | 1.12 | 1.05 | C | C | C | C | C |
| dm12 | tm12 | CA1 | Yes | 1.21 | 1.19 | C | C | C | C | C |
| dm13 | tm13 | CA1 | Yes | 1.31 | 1.24 | C | C | C | C | C |
| dm14 | tm14 | CA1 | Yes | 1.36 | 1.19 | C | C | C | C | C |
| dm15 | tm15 | CA1 | Yes | 1.19 | 0.98 | C | C | C | C | C |
| DM16 | TM16 | CA1 | No | 1.41 | 1.38 | A | A | A | A | A |
| DM17 | TM17 | CA1 | No | 1.48 | 1.40 | A | A | A | A | A |
| DM18 | TM18 | CA1 | No | 1.38 | 1.32 | B | A | B | A | A |
| DM19 | TM19 | CA1 | No | 1.39 | 1.31 | B | A | B | A | A |
| DM20 | TM20 | CA1 | No | 1.44 | 1.48 | A | A | A | A | A |
| DM21 | TM21 | CA1 | No | 1.41 | 1.32 | A | A | A | A | A |
| DM22 | TM22 | CA1 | No | 1.42 | 1.42 | A | A | A | A | A |
| DM23 | TM23 | CA1 | No | 1.41 | 1.42 | A | A | A | A | A |
| DM24 | TM24 | CA1 | No | 1.42 | 1.44 | A | A | A | A | A |
| DM25 | TM25 | CA1 | No | 1.38 | 1.34 | B | A | B | A | A |
| DM26 | TM26 | CA1 | No | 1.39 | 1.32 | B | A | B | A | A |

With respect to the whole-page solid image uniformity, “A” means that there was little local image density variation and little difference in image density when a whole-page solid image sample was created on an A4-size sheet, and “C” means that there was a noticeable difference in image density in some places.

With respect to the omission of characters, “A” means that there was little toner present around the lines when Chinese characters [symbol] were formed and then the presence of toner around the lines was evaluated, “B” means that there was some toner present around the lines, and “C” means that there was a large amount of toner present around the lines.

The term “reverse transfer” refers to a phenomenon in which when an image sample of two or more colors is created and when a toner of the first color is transferred to a transfer belt from a photoconductive member and then a toner of the second color is transferred to the transfer belt from another photoconductive member, part of the toner of the first color is adhered to the photoconductive member of the second color. The evaluation thereof was carried out by visually inspecting the amount of toner collected in a waste toner box when the toner of the first color was adhered to the photoconductive member of the second color and removed from the photoconductive member by a cleaning blade. “A” means that the toner of the first color and the toner of the second color were barely mixed, and “C” means that the mixing of the toner of the first color and the toner of the second color was clearly noticeable.

With respect to the transfer void, a pattern created by two intersecting lines, i.e., “+”, was printed, and the presence of toner in the intersection was evaluated. “A” means that toner was present at the intersection, “B” means that there were some portions in the intersection that lack toner, and “C” means that there was no toner present in the intersection.

As for the two-component developers DM1 to DM10 and DM16 to DM26 in which the toners of the present invention were used, the filming of toner over the photoconductor member when a long-term test by outputting 100000 A4-size sheets was carried out was not a problem for practical use. In addition, the filming of toner over the transfer belt was also not a problem for practical use. Moreover, no cleaning failure of the transfer belt occurred. In a full-color image in which the three colors overlap, the phenomenon of paper being wound around the fixing belt did not occur.

With respect to the image density before and after the long-term test, high-density images having an image density of 1.3 or more were obtained from all of the two-component developers DM1 to DM10 and DM16 to DM26 in which the toners of the present invention were used. In addition, after the long-term test by outputting 100000 A4-size sheets also, the flowability of the two-component developers was stable, and the image density was barely changed at 1.3 or more, showing that the two-component developers are stable in property.

With respect to the fogging of non-image portions and the uniformity of a whole-page solid image, high image density was obtained, no background fogging of non-image portions was generated, no toner scattering occurred, and high resolution was obtained with all the two-component developers DM1 to DM10 and DM16 to DM26 of the present invention. The uniformity of a developed whole-page solid image was also good. With respect also to transferability (omission of characters, reverse transfer and transfer void during transfer), spots and the like were not a problem for practical use. In a full-color image in which the three colors overlap, no transfer failure occurred. The transfer efficiency was 95%.

However, with DM18, DM19, DM25 and DM26, fogging and the phenomenon of some characters not being transferred occurred more than with the other toners, but these toners were still within the practically usable level.

However, with DM18, DM19, DM25 and DM26, fogging and the phenomenon of some characters not being transferred occurred more than with the other toners, but these toners were still at the practically usable level.

On the other hand, dm11 to dm15 prepared for comparison had large amounts of suspended particles, and thus the image densities were low and samples that could withstand the image evaluation were not obtained.

With respect to the level of fogging created by DM1 to DM4, dm11 and dm12, FIG. 5 shows the results of a thorough relative evaluation using a spectrolino spectro scan manufactured by Gretag Macbeth. The horizontal axis indicates the amount of DBP of carbon black particles, and the vertical axis indicates the reflection density with fogging. The practically acceptable range based on a sensory evaluation is 0.1 or less.

Table 16 shows the results of the evaluation in connection with fixability, offset resistance, high-temperature storage stability and the possibility of paper being wound around the fixing belt. In the table, “A” means that the result of the evaluation was good, indicating that no thermal aggregation occurred after being left to stand in high temperatures and the particulate state is maintained. “C” means that the result of the evaluation was unsatisfactory, indicating that a toner after being left to stand in high temperatures aggregated and the aggregated toner did not break unless a load of 300 g/cm² or more was applied. Here, a solid image was fixed in an amount of 1.2 mg/cm² at a process speed of 125 mm/s using a fixing device provided with an oilless belt, and the OHP film transmittance (fixing temperature: 160° C.), the minimum fixing temperature and the temperature at which offset occurs at high temperatures were measured. For the high-temperature storage stability test, the condition of a toner after being left to stand at 50° C. for 24 hours was evaluated. The OHP film transmittance was measured with 700 nm light using a spectrophotometer (U-3200, manufactured by Hitachi, Ltd.).

TABLE 16

| | Evaluation | | | |
|---|---|---|---|---|
| | Minimum | Temperature (° C.) | | |
| | fixing | at which | Storage | Winding of |
| | temperature | high-temperature | stability | paper around |
| Toner | (° C.) | offset occurs | test | the fixing belt |
| TM1 | 125 | 195 | A | Not occurred |
| TM2 | 130 | 195 | A | Not occurred |
| TM3 | 135 | 195 | A | Not occurred |
| TM4 | 145 | 200 | A | Not occurred |
| TM5 | 130 | 220 | A | Not occurred |
| TM6 | 130 | 215 | A | Not occurred |
| TM7 | 135 | 215 | A | Not occurred |
| TM8 | 135 | 210 | A | Not occurred |
| TM9 | 130 | 220 | A | Not occurred |
| TM10 | 140 | 210 | A | Not occurred |
| tm11 | 170 | 190 | C | Occurred |
| tm12 | 175 | 185 | C | Occurred |
| tm13 | 180 | 190 | C | Occurred |
| tm14 | 180 | 190 | C | Occurred |
| tm15 | No window | | C | Occurred |
| TM16 | 135 | 195 | A | Not occurred |
| TM17 | 125 | 195 | A | Not occurred |
| TM18 | 140 | 210 | A | Not occurred |
| TM19 | 145 | 205 | A | Not occurred |
| TM20 | 135 | 195 | A | Not occurred |
| TM21 | 135 | 195 | A | Not occurred |
| TM22 | 130 | 215 | A | Not occurred |
| TM23 | 135 | 210 | A | Not occurred |
| TM24 | 140 | 210 | A | Not occurred |
| TM25 | 150 | 205 | A | Not occurred |
| TM26 | 150 | 200 | A | Not occurred |

In the fixability evaluation, TM11 to TM10 and TM16 to TM26 containing a wax having a specific melting point showed a low-temperature fixability of 145° C. or less and a high-temperature offset resistance of 195° C. The high-temperature storage stability was also good. In tm11 to tm15, the low-temperature fixability and the high-temperature offset resistance were poor, and no satisfactory fixable temperature range was obtained. It therefore seems that the compatibilization with the resin was hampered by the adsorption of the wax onto the carbon black particles, and low-temperature fixability is thus barely attainable.

### INDUSTRIAL APPLICABILITY

The present invention is advantageous not only for an electrophotographic system in which a photoconductive member is used, but also for a printing system in which toner containing a conductive material adheres directly to paper or a substrate having a circuit pattern.

1. A toner comprising core particles prepared by mixing and aggregating in an aqueous medium at least a first resin particle dispersion in which first resin particles are dispersed, a colorant particle dispersion in which particles of colorant are dispersed and a wax particle dispersion in which particles of wax are dispersed, wherein
a surfactant for use in the first resin particle dispersion contains a nonionic surfactant in a proportion of 50 to 95 wt. % based on the entire surfactant,
the colorant contains carbon black having a DBP oil absorption of 45 to 70 (ml/100 g),
the wax contains a wax having an endothermic peak temperature according to a DSC method of 50 to 90° C.

2. The toner according to claim 1, wherein
a surfactant for use in each of the first resin particle dispersion, the colorant particle dispersion and the wax particle dispersion is a mixture of a nonionic surfactant and an ionic surfactant, and
in the surfactants used in the particle dispersions, the proportion of ionic surfactant with the entire surfactant is larger in the first resin particles than in the particles of colorant and is larger in the particles of colorant than in the particles of wax.

3. The toner according to claim 1, wherein
a surfactant for use in the first resin particle dispersion is a mixture of a nonionic surfactant and an ionic surfactant, and
a surfactant for use in each of the colorant particle dispersion and the wax particle dispersion contains only a nonionic surfactant as a principal component.

4. The toner according to claim 1, wherein
the first resin particle dispersion is dispersed with a mixed surfactant of a nonionic surfactant and an anionic surfactant,
the colorant particle dispersion is dispersed with a nonionic surfactant,
the wax particle dispersion is dispersed with a nonionic surfactant, and
the average number of moles of ethylene oxide added to the nonionic surfactant for dispersing the particles of wax is greater than the average molar number of ethylene oxide added of the nonionic surfactant for dispersing the particles of colorant.

5. (canceled)

6. The toner according to claim 1, wherein
the wax comprises at least a first wax and a second wax,
the first wax has an endothermic peak temperature (melting point: Tmw1 (° C.)) according to the DSC method of 50 to 90° C., and
the second wax has an endothermic peak temperature (melting point: Tmw2 (° C.)) according to the DSC method of 80 to 120° C.

7. The toner according to claim 1, wherein
the wax comprises at least a first wax and a second wax,
the first wax contains an ester wax composed of at least a higher alcohol having 16 to 24 carbon atoms or a higher fatty acid having 16 to 24 carbon atoms, and
the second wax contains an aliphatic hydrocarbon wax.

8. The toner according to claim 1, wherein the wax comprises at least a first wax and a second wax,
the first wax contains a wax having an iodine value of 25 or less and a saponification value of 30 to 300, and
the second wax contains an aliphatic hydrocarbon wax.

9. The toner according to claim 6, wherein the melting point of the second wax is 5 to 50° C. higher than the melting point of the first wax.

10. A method for producing a toner comprising the steps of:
preparing a mixture by mixing in an aqueous medium at least a first resin particle dispersion in which first resin particles are dispersed, a colorant particle dispersion in which particles of colorant are dispersed and a wax particle dispersion in which particles of wax are dispersed,
preparing core particles by adding an aggregating agent to the mixture, and aggregating and fusing the first resin particles, the particles of colorant and the particles of wax, and
fusing second resin particles with the core particles by adding a second resin particle dispersion in which the second resin particles are dispersed to a core particle dispersion containing the core particles, followed by heating, wherein
a surfactant for use in the first resin particle dispersion contains a nonionic surfactant in a proportion of 50 to 95 wt. % based on the entire surfactant,
the colorant contains carbon black having a DBP oil absorption of 45 to 70 (ml/100 g), and
the wax contains a wax having an endothermic peak temperature according to a DSC method of 50 to 90° C.

11. The method for producing a toner according to claim 10, wherein
the core particles are prepared by preparing a mixture by mixing the first resin particle dispersion in which first resin particles are dispersed, the colorant particle dispersion in which particles of colorant are dispersed and the wax particle dispersion in which particles of wax are dispersed, performing a heat treatment, and then adding an aggregating agent.

12. The method for producing a toner according to claim 10, wherein
the aggregating agent is added after the fluid temperature of the mixture in which the first resin particle dispersion, the colorant particle dispersion and the wax particle dispersion are mixed and reaches the melting point of the wax or higher.

13. The method for producing a toner according to claim 10, wherein
a surfactant for use in each of the first resin particle dispersion, the colorant particle dispersion and the wax particle dispersion is a mixture of a nonionic surfactant and an ionic surfactant, and
in the surfactants used in the particle dispersions, the proportion of ionic surfactant based on the entire surfactant is larger in the first resin particles than in the particles of colorant and larger in the particles of colorant than in the particles of wax.

14. The method for producing a toner according to claim 10, wherein
a surfactant for use in the first resin particle dispersion is a mixture of a nonionic surfactant and an ionic surfactant, and
a surfactant for use in each of the colorant particle dispersion and the wax particle dispersion contains only a nonionic surfactant as a principal component.

15. The method for producing a toner according to claim 10, wherein
the first resin particle dispersion is dispersed by a mixed surfactant of a nonionic surfactant and an anionic surfactant,
the colorant particle dispersion is dispersed by a nonionic surfactant,
the wax particle dispersion is dispersed by a nonionic surfactant, and
the average number of moles of ethylene oxide added to the nonionic surfactant for dispersing the particles of wax is greater than the average molar number of ethylene oxide added of the nonionic surfactant for dispersing the particles of colorant.

16. (canceled)

17. The method for producing a toner according to claim 10, wherein
the wax comprises at least a first wax and a second wax,
the first wax has an endothermic peak temperature (melting point: Tmw1 (° C.)) according to the DSC method of 50 to 90° C., and
the second wax has an endothermic peak temperature (melting point: Tmw2 (° C.)) according to a DSC method of 80 to 120° C.

18. The method for producing a toner according to claim 10, wherein
the wax comprises at least a first wax and a second wax,
the first wax contains an ester wax composed of at least a higher alcohol having 16 to 24 carbon atoms or a higher fatty acid having 16 to 24 carbon atoms, and
the second wax contains an aliphatic hydrocarbon wax.

19. The method for producing a toner according to claim 10, wherein
the wax comprises at least a first wax and a second wax,
the first wax contains a wax having an iodine value of 25 or less and a saponification value of 30 to 300, and
the second wax contains an aliphatic hydrocarbon wax.

20. The method for producing a toner according to claim 10, wherein
the melting point of the second wax is 5 to 50° C. higher than the melting point of the first wax.
